(19) United States
(12) Patent Application Publication
(10) Pub. No.: US 2025/0029135 A1
(43) Pub. Date: Jan. 23, 2025

(54) SYSTEMS AND METHODS FOR PRIORITIZATION AND VALIDITY MONITORING OF SHARED LINKS

(71) Applicant: Capital One Services, LLC, McLean, VA (US)

(72) Inventors: Joshua EDWARDS, Philadelphia, PA (US); Kevin OSBORN, Newton Highlands, MA (US); Leeyat Bracha TESSLER, Arlington, VA (US); Renee GILL, New York, NY (US)

(73) Assignee: Capital One Services, LLC, McLean, VA (US)

(21) Appl. No.: 18/353,304

(22) Filed: Jul. 17, 2023

(51) Int. Cl. G06Q 30/0214; G06Q 30/0235

(52) U.S. Cl. CPC G06Q 30/0214; G06Q 30/0235

(57) ABSTRACT

Disclosed are methods and systems for prioritization and/or validity monitoring of shared links. For instance, a share request for a link associated with a site may be received from a sharing user computing device. The link and associated information, including a valid status, may be stored. An interaction with the site on a receiving user computing device may be detected, and the link may be determined to be valid based on the stored information. A notification including the stored link may be generated and displayed on the receiving user computing device to prompt code use. Interactions indicating code use may be monitored for, code use may be detected, and the status may be updated to invalid. If a plurality of links associated with the site have been received, the links may be prioritized for inclusion in the notification based on a determined priority among sharing users of the links.

### TECHNICAL FIELD

Various aspects of this disclosure relate generally to techniques for sharing links, and, more particularly, to systems and methods for prioritizing among a plurality of shared links received by a receiving user and/or validity monitoring of shared links, including shared links having non-reusable and limited-use codes.

### BACKGROUND

Many merchants utilize referral systems, among other similar types of promotional, discount, and/or coupon-related systems. For example, after a user completes a transaction with a merchant, the merchant may provide the user a link that has an associated code to share with other users. The shared link may be displayed to the other users, where the code may be redeemed by one or more of the other users to apply an offer, deal, promotion, discount, or the like from the merchant. If redeemed, the sharing user may receive a bonus, reward, or other similar incentive.

In some examples, one of the users having received the shared link may have been referred a similar link from the merchant by multiple sharing users, and the referral system may have to determine which of the shared links from the merchant to display. Additionally, in some instances, the associated code of the shared link may be a non-reusable code (e.g., a one-time use code) and/or a reusable code that is limited to a particular number of uses. Therefore, once one of the other users having received the link redeems the code, the remaining users who received the link may be unable to use that link. Thus, it may be desirable to implement a monitoring mechanism that enables removal and/or replacement of the link so it is no longer displayed to the other users once redeemed.

This disclosure is directed to addressing the above-referenced challenges, among other challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for prioritization and/or validity monitoring of shared links. The systems and methods may include prioritizing among a plurality of shared links associated with a site that have been received by a receiving user from a plurality of sharing users. Additionally, the systems and methods may include updating a validity status of a shared link including a non-reusable code and/or a limited use code upon detecting use of the code.

In some aspects, the techniques described herein relate to computer-implemented methods. An example method may include detecting an interaction with a site on a computing device associated with a receiving user, and determining the receiving user has received a plurality of shared links associated with the site from a plurality of sharing users, where each of the plurality of shared links and information associated with the plurality of shared links, including a validity status of the plurality of shared links, may be stored in a data store. The example method may also include determining a priority of the plurality of sharing users based on a prioritization mechanism associated with the receiving user, and based on the priority, generating and providing a notification for display on the computing device. The notification may include at least one shared link from the plurality of shared links that is associated with a highest priority sharing user based on the determined priority. The example method may further include detecting a use of a code associated with the at least one shared link, and based on the use of the code, updating a validity status of the at least one shared link stored in the data store from valid to invalid.

In other aspects, another example method may include receiving a request from a first computing device associated with a sharing user to share a link with a first receiving user and a second receiving user, where the link is associated with a site and includes a code that is non-reusable, and storing the link and information associated with the link, including a validity status of the link as valid and conditions for using the code, in a data store. The other example method may also include detecting an interaction with the site on a second computing device associated with the first receiving user, generating and providing a first notification including the link for display on the second computing device, monitoring for interactions indicating a use of the code based on the conditions stored in the data store, and detecting the use of the code based on the monitoring. The other example method may further include, based on the use of the code, updating the validity status of the link from valid to invalid in the data store, generating and providing a second notification to the first computing device to indicate the use and prompt provision of a new link associated with the site to share with the second receiving user, and receiving the new link. When an interaction with the site is detected on a third computing device associated with the second receiving user, the new link may be included in a third notification generated and provided for display on the third computing device.

In further aspects, a further example method may include receiving a request from a first computing device associated with a sharing user to share a link with a plurality of receiving users, where the link is associated with a site and includes a code that is non-reusable, and storing the link and information associated with the link, including a validity status of the link as valid and conditions for using the code, in a data store. The further example method may also include detecting an interaction with the site on a second computing device associated with a first receiving user of the plurality of receiving users, generating and displaying a notification including the link on the second computing device, and monitoring for interactions indicating a use of the code based on the conditions stored in the data store. The further example method may further include detecting the use of the code based on the monitoring, and updating the validity status of the link stored in the data store from valid to invalid such that the link is not displayed to a second receiving user of the plurality of receiving users when an interaction with the site is detected on a third computing device associated with the second receiving user.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for link sharing, according to certain aspects.

FIG. 2 depicts a flowchart of an exemplary link prioritization process, according to certain aspects.

FIG. 3A depicts a flowchart of an exemplary process for monitoring a validity of a shared link, according to certain aspects.

FIG. 3B depicts a flowchart of another exemplary process for monitoring a validity of a shared link, according to certain aspects.

FIG. 3C depicts a flowchart of a further exemplary process for monitoring a validity of a shared link, according to certain aspects.

FIG. 4 depicts a flowchart of an exemplary process for training a machine learning model to predict a user-specific likelihood of engagement with a shared link, according to certain aspects.

FIG. 5 depicts a block diagram of an exemplary process for training and using a machine learning model to predict a user-specific likelihood of engagement with a shared link, according to certain aspects.

FIG. 6 depicts an exemplary shared link notification provided to a receiving user, according to certain aspects.

FIG. 7 depicts another exemplary shared link notification provided to a receiving user, according to certain aspects.

FIG. 8 depicts an exemplary use notification provided to a sharing user, according to certain aspects.

FIG. 9 depicts an exemplary reward notification provided to a sharing user, according to certain aspects.

FIG. 10 depicts an example of a computer, according to certain aspects.

### DETAILED DESCRIPTION

According to certain aspects of the disclosure, methods and systems are disclosed for link sharing. As will be discussed in more detail below, in various aspects, systems and methods are described for prioritizing among a plurality of shared links received by a receiving user and/or monitoring a validity of shared links, including shared links having non-reusable and limited-use codes

As briefly discussed above, many merchants utilize referral systems, among other similar types of promotional, discount, and/or coupon-related systems. For example, after a user completes a transaction with the merchant, the merchant may provide the user a link to share with other users (e.g., receiving users). A portion of the link may include a code. The code may be redeemed by a receiving user to apply an offer, deal, promotion, discount, or the like from the merchant. In some examples, if the code is redeemed by one or more of the receiving users, the sharing user may receive a bonus, reward, or other similar incentive.

Systems and methods are described herein to prioritize among a plurality of shared links received by a receiving user. For example, one of the receiving users having received the shared link may have been referred a similar link from the merchant by multiple sharing users. A priority among the multiple sharing users may be determined, and at least one of the shared links associated with a highest priority sharing user may be included in a notification displayed to the receiving user.

Additionally, systems and methods are described herein for monitoring a validity of shared links. For example, in some instances, the associated code of the shared link may be a non-reusable code (e.g., a one-time use code) and/or limited to a number of uses. Therefore, interactions indicating use of the code may be monitored for, and upon detecting use, the link may be invalidated to prevent the link from being presented to any other users with whom the link was initially shared.

Reference to any particular activity is provided in this disclosure only for convenience and is not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” may convey “based at least in part on.” The singular forms “a,” “an,” and “the” may include plural referents unless the context dictates otherwise. The term “exemplary” may be used in the sense of “example” rather than “ideal.” The terms “comprises,” “comprising,” “includes,” “including,” or other variations thereof, may convey a non-exclusive inclusion such that a process, method, or product that comprises a list of elements does not necessarily include only those elements, but may include other elements not expressly listed or inherent to such a process, method, article, or apparatus. The term “or” may be interpreted disjunctively, such that “at least one of A or B” includes, (A), (B), (A and A), (A and B), etc. Similarly, the term “or” is intended to mean “and/or,” unless explicitly stated otherwise. “And/or” may convey all permutations, combinations, subcombinations, and individual instances of items or terms included within a list of the items or terms. Relative terms, such as, “substantially” and “generally,” may be used to indicate a possible variation of ±10% of a stated or understood value.

Terms like “provider,” “merchant,” or the like may generally encompass an entity or person involved in providing, selling, and/or renting items to persons such as a seller, dealer, renter, merchant, vendor, or the like, as well as an agent or intermediary of such an entity or person. An “item” may generally encompass a good, service, or the like having ownership or other rights that may be transferred. As used herein, terms like “account user” or “user” generally encompass any person or entity that may have a link sharing account and consume link sharing services from a provider (e.g., through a link sharing application). The same person or entity may also have a financial account, such as a credit card or debit card account, and consume financial services from a same or different provider (e.g., through a financial application), where interaction history information from the financial account may be associated with the link sharing account. Additionally, the same person or entity may also have a communication account, such as an electronic mail or other similar electronic messaging account, and consume communication services from a different provider (e.g., through a communication application). The term “application” may be used interchangeably with other terms like “program,” or the like, and generally encompasses software that is configured to interact with, modify, override, supplement, or operate in conjunction with other software.

A “sharing user” or “referrer” may be a user that is utilizing the link sharing services to share a link associated with a merchant. A “receiving user” or “referee” may be a user that has been selected by the sharing user to receive the link shared by the sharing user, and may be capable of redeeming a code associated with the link. A “link” may generally include a uniform resource locator (URL) to a page of a merchant site and a merchant-provided code that may be used or redeemed by the receiving user to apply an offer, promotion, discount, deal, or the like on an item sold by the merchant and/or on any transaction with the merchant generally through the merchant site.

As used herein, a “machine learning model” may generally encompass instructions, data, and/or a model configured to receive input, and apply one or more of a weight, bias, classification, or analysis on the input to generate an output. The output may include, e.g., a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. The training data may be generated, received, and/or otherwise obtained from internal or external resources. Aspects of a machine learning system may operate on an input linearly, in parallel, via a network (e.g., a neural network), or via any suitable configuration.

In an exemplary use case, a sharing user may share a link, such as a referral link, with a plurality of receiving users. The link may be provided by a merchant associated with a site. The link may include a code. The code may be a nonreusable (e.g., a one-time use) or a limited use code that is redeemable by one or more of the receiving users. The link may be valid prior to the code being used or redeemed. The link and information associated with the link, including a validity status of the link as valid and conditions for using the code, may be stored in a data store. The conditions for using the code may indicate one or more interactions to be performed for the code to be used (e.g., the conditions may indicate referral completion steps).

When an interaction with the site is detected on a computing device of one of the receiving users, a notification including the link may be generated and displayed to prompt the receiving user to redeem the code. In some examples, prior to generating the notification, a determination may be made as to whether that receiving user has received multiple links associated with the site from multiple sharing users. If so, a priority among the sharing users may be determined based on a prioritization mechanism, and one or more of the multiple links may be displayed according to the priority. Additionally and/or alternatively, prior to generating the notification, a likelihood of the receiving user engaging with the link may be determined, and the notification may be generated and displayed based on a positive determination.

Interactions indicating a use of the code by the receiving user may then be monitored for based on the conditions that are stored in the data store. Upon detecting a use of the code, a validity status of the link may be updated from valid to invalid in the data store. Resultantly, the invalid link may no longer be displayed to any of the other receiving users whom the sharing user shared the link with. In some examples, the sharing user may be informed of the use, and prompted to provide new, valid links for distribution to the remaining receiving users and/or new users. In such examples, the invalid link may be replaced with the new, valid links provided in response. In further examples, when the use of the code is detected, a reward status associated with the sharing user may be incremented to enable subsequent comparison and/or updating based on merchant-provided reward information.

While specific examples included throughout the present disclosure involve referral links and associated referral codes, it should be understood that techniques according to this disclosure may be adapted to other types of sharable links having associated codes, such as promotional links, coupon links, and/or other similar offers provided via links. It should also be understood that the examples above are illustrative only. The techniques and technologies of this disclosure may be adapted to any suitable activity.

Presented below are various aspects of machine learning techniques that may be adapted for determining a user-specific likelihood of engagement with a shared link. As will be discussed in more detail below, the machine learning techniques may include one or more aspects according to this disclosure, e.g., a particular selection of training data, a particular training process for the machine learning system, operation of the machine learning system in conjunction with particular data, modification of such particular data by the machine learning system, etc., and/or other aspects that may be apparent to one of ordinary skill in the art based on this disclosure.

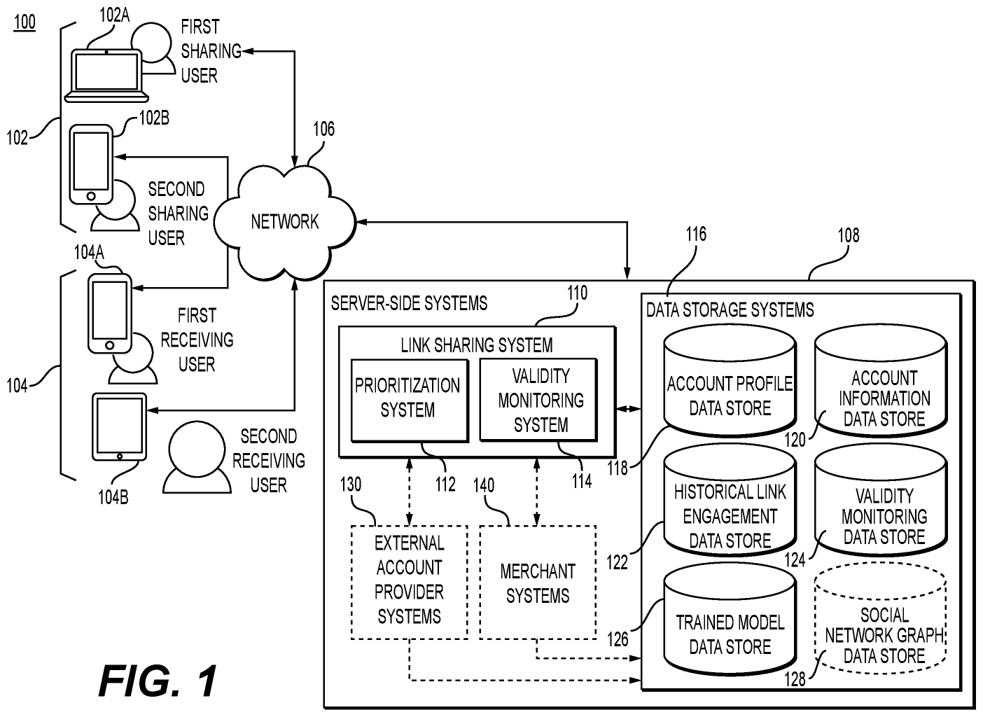

FIG. 1 depicts an exemplary environment 100 for link sharing, according to certain aspects, and which may be used with the techniques presented herein. One or more user computing devices 102 of sharing users, hereinafter sharing user computing devices 102, may communicate with one or more of the other components of the environment 100 across electronic network 106, including one or more server-side systems 108, discussed below, to share a link with one or more receiving users. The environment 100 of FIG. 1 shows a first sharing user computing device 102A of a first sharing user and a second sharing user computing device 102B of a second sharing user. However, in other examples, there may be more or fewer sharing user computing devices 102, including multiple sharing user computer devices 102 for each of one or more sharing users.

Additionally, one or more computing devices 104 of the receiving users, hereinafter receiving user computing devices 104, may communicate with one or more of the other components of the environment 100 across electronic network 106, including the server-side systems 108, to receive and/or engage with the link shared by the sharing user to use or redeem an associated code of the link. The environment 100 of FIG. 1 shows a first receiving user computing device 104A of a first receiving user and a second receiving user computing device 104B of a second receiving user. However, in other examples, there may be more or fewer receiving user computing devices 104, including multiple receiving user computer devices 104 for each of one or more sharing users.

Each of the sharing users and the receiving users may have a respective user account for link sharing services of a provider (e.g., a respective link sharing account). In some examples, the receiving users of a given sharing user may be part of a group of users associated with the sharing user (e.g., friends, connections, or associates of the sharing user) defined by and/or otherwise established via a social network graph maintained as part of the link sharing services, as described in detail elsewhere herein. In other link sharing interactions, the sharing users may be receiving users of shared links and/or the receiving users may be sharing users of shared links.

The server-side systems 108 may include at least a link sharing system 110 and/or one or more data storage systems 116. Additionally, the server-side systems 108 may include one or more optional external account provider systems 130 and one or more optional merchant systems 140. The optional external account provider systems 130 may include systems of financial account providers that provide financial accounts to users. Additionally or alternatively, the optional external account provider systems 130 may include systems of communication account providers that provide communication accounts to users (e.g., electronic mail services, electronic messaging services, etc.). The optional merchant systems 140 may include systems of merchants that are providing the links.

In some aspects, the link sharing system 110, at least one of the data storage systems 116, and/or at least one of the optional external account provider system(s) 130 (e.g., at least one financial account provider system) may be associated with a common entity, e.g., the provider of the link sharing services, or the like. In such an embodiment, the provider may provide link sharing accounts to a plurality of users, financial accounts to a subset (or all) of the plurality of users, and data storage services. In such aspects, the link sharing system 110, the at least one of the data storage systems 116, and/or the at least one of the optional external account provider system(s) 130 may be part of a cloud service computer system (e.g., in a data center).

In other aspects, one or more of the components of the environment 100 may be associated with a different entity than another. For example, the link sharing system 110 may be associated with the provider, and one or more of the optional external account provider systems 130 may be associated with one or more third parties that provide financial account services and/or communication account services to a plurality of users, including a subset of users that also have link sharing accounts through the provider. Accordingly, the third parties may provide access to financial account information and/or communication-related information for the subset of users to the link sharing system 110 to be used for link sharing functionalities, as described in detail below. Additionally or alternatively, one or more of the data storage systems 116 may be associated with a third party that provides data storage services to the provider.

The above-provided examples are exemplary and non-limiting. The systems and devices of the environment 100 may communicate in any arrangement. As will be discussed herein, systems and/or devices of the environment 100 may communicate in order to enable link sharing, among other activities.

Each of the sharing user computing devices 102 and the receiving user computing devices 104 may be configured to enable a respective user to access and/or interact with other systems in the environment 100. For example, the sharing user computing devices 102 and/or the receiving user computing devices 104 may be a computer system such as, for example, a desktop computer, a laptop computer, a tablet, a smart cellular phone, a smart watch or other electronic wearable, etc.

In some aspects, the sharing user computing devices 102 and/or the receiving user computing devices 104 may include one or more electronic application(s), e.g., a program, plugin, browser extension, etc., installed on a memory of the respective computing device(s) 102, 104. Additionally, the electronic application(s) may be associated with one or more of the other components in the environment 100. For example, a link sharing application associated with the link sharing system 110 may be executed on the sharing user computing devices 102 and/or the receiving user computing devices 104 to enable the linking sharing services of the provider.

In some examples, the application is a browser extension application that adds functionality, such as link sharing functionalities, to a web browser launched on the sharing user computing devices 102 and/or the receiving user computing devices 104. In other examples, the application may be a thick client application that is installed locally on the sharing user computing devices 102 and/or the receiving user computing devices 104 (e.g., a desktop application or mobile application). In further examples, the application may be a thin client application (e.g., a web application) that is rendered via the web browser launched on the sharing user computing devices 102 and/or the receiving user computing devices 104.

Additionally, one or more components of the sharing user computing devices 102 and/or the receiving user computing devices 104 may generate, or may cause to be generated, one or more graphical user interfaces based on instructions/information stored in the memory, instructions/information received from the other systems in the environment 100, and/or the like and may cause the graphical user interfaces to be displayed via a display of the sharing user computing devices 102 and/or the receiving user computing devices 104. The graphical user interfaces may be, e.g., mobile application interfaces or browser user interfaces and may include text, input text boxes, selection controls, and/or the like. The display may include a touch screen or a display with other input systems (e.g., a mouse, keyboard, etc.) for the user to control the functions of the sharing user computing devices 102 and/or the receiving user computing devices 104.

The link sharing system 110 may include one or more server devices (or other similar computing devices) for executing link sharing services of the provider. As described in detail elsewhere herein, example link sharing services may include one or more of: receiving a request from a sharing user to share a link associated with a site with one or more receiving users; distributing the link to one or more of the receiving users; monitoring for and detecting an interaction with the site by one of the receiving users; generating and providing a notification that includes the link for display to prompt use of a code associated with the link; and/or monitoring for interactions indicating use of the code by the receiving user.

Additional example link sharing services may include prioritization services, such as: determining whether a receiving user has received multiple links and if so, prioritizing the links for inclusion within the notification; and/or determining whether the receiving user is likely to engage with the link, where the determination may impact whether and what type of notification is generated. Further link sharing services may include validity monitoring services for at least a subset of links shared that include codes that are non-reusable (e.g., one-time use codes) and/or may be used only a predefined number of times. For example, an initial valid status of the link may be stored when the request to share the link is received, and the status may be updated to invalid when the use of the code is detected (and the code is either a one-time use code or the detected use meets the predefined number of times) based on the above-described monitoring. In some examples, when the sharing user initially shared the link having the one-time or limited use code with multiple receiving users and the link is now invalid, the invalid link may be removed from accounts of (e.g., and thus will no longer be displayed to) any remaining receiving users that had not yet used the code. Additionally, the link sharing system 110 may also facilitate the prompting of new links from the sharing user for distribution to those remaining receiving users (e.g., to replace the invalid links).

In some examples, the link sharing system 110 may include one or more sub-systems for performing different aspects or functions of the link sharing services. As shown, one exemplary sub-system may include a prioritization system 112 for performing the prioritization services and a validity monitoring system 114 for performing the validity monitoring services. As described elsewhere herein, at least the prioritization system 112 may deploy a trained machine learning model to, for example, determine whether the receiving user is likely to engage with the link.

The data storage systems 116 may each include a server system or computer-readable memory such as a hard drive, flash drive, disk, etc. In some aspects, the data storage systems 116 include and/or interact with an application programming interface for exchanging data to other systems, e.g., one or more of the other components of the environment, such as at least the link sharing system 110 and/or one or more of the optional external account provider systems 130 or optional merchant systems 140. In some examples, one or more of the data storage systems 116 may be a sub-system or component of the link sharing system 110 (e.g., when the data storage system 116 is also provided by the provider rather than a third party).

The data storage systems 116 may include and/or act as a repository or source for various types of user account-related data for the link sharing services. For example, the data storage systems 116 may include a plurality of data stores, including an account profile data store 118, an account information data store 120, a historical link engagement data store 122, a validity monitoring data store 124, and/or a trained model data store 126, among other data stores. Additionally, when the link sharing system 110 includes a social network graph that facilitates and captures relationships or associations between user accounts, the data storage systems 116 may include an optional social network graph data store 128. In some examples, the data stores 118, 120, 122, 124, 126, and 128 may store the various types of link sharing account-related data in association with an identifier of each link sharing account (e.g., an account number, user name, or other similar identifier).

The account profile data store 118 may store profile information for each of the plurality of link sharing accounts. The profile information may include account identifiers (e.g., an account number), user information (e.g., name, contact information, QR codes, or other unique identifiers associated with the user), and/or account settings or preferences of the user, among other similar information (e.g., preference for prioritization mechanism, preference for receiving notifications, etc.).

The account information data store 120 may include link sharing interactions associated with each of the link sharing accounts, among other account related interactions. Exemplary link sharing interactions may include shared links, forwarded shared links, pending rewards, received rewards, redeemed rewards, or received, engaged links, and/or redeemed links, among other similar interactions. For example, for a link shared by a sharing user to one or more receiving users, a data entry for the link may be generated and stored in association with the link sharing account of the sharing user and/or link sharing account of the receiving users within account information data store 120. The data entry includes a plurality of data fields identifying information associated with the link and/or interactions with the link, as described in detail elsewhere herein.

The historical link engagement data store 122 may store data associated with link engagement behavior of each user of the link sharing accounts. For example, for a given account, the data stored may include information associated with past links received and an indication of whether the past links were engaged with and/or a level of engagement. Information associated with the past links may include a merchant, an item, an offer, a sharing user, and/or a notification display context associated with the past link. Engagement may include at least a selection of the link, the selection causing navigation to a page of a site of an associated merchant indicated by the URL included in the link. Levels of engagement may include selection of the link, use or redemption of the code associated with the link, and/or any forwarding or downstream sharing of the link, among other similar examples. The past links may be associated with a timestamp indicating a time at which the past links were received by the respective user. In some examples, the historical link engagement data store 122 may retrieve at least portions of the link engagement behavior data from the account information data store 120.

The validity monitoring data store 124 may store data associated with validity statuses of links shared by sharing users. For example, for each link, a data entry for the link may be generated in the validity monitoring data store 124. The data entry for the link may include a plurality of data fields. Example data fields may include fields representing an identifier of a link sharing account of the sharing user of the link, one or more identifiers of link sharing accounts of one or more receiving users that the sharing user selected to share the link with, one or more conditions for use of the code (e.g., referral completion conditions), a use-type of the code (e.g., non-reusable, limited reusable including the predefined number of uses, or unlimited reusable), a number of uses of the code, and/or a validity status of the link (e.g., valid or invalid). Initially, the validity status of the link may be recorded as valid in the data entry for the link. In some examples, the validation-related data entry for the link may be stored in combination with the data entry stored in the account information data store 120 (e.g., as one larger data entry for the data link).

As described in detail elsewhere herein, as the validity monitoring system 114 is monitoring for interactions indicating a use of the code by one of the receiving users, and detects one of the conditions has been met, the data entry for the link may be updated to indicate the corresponding condition has been completed. Once all the conditions have been met, and a maximum number of uses of the code has been reached (e.g., based on the use-type and the number of uses recorded in the data entry), the validity status of the link may be updated to invalid in the data entry. Additionally, in some examples, the data entry field representing the number of uses of the code may be used as part of a reward tracking feature for the sharing user that is deployed by the validity monitoring system 114.

The trained model data store 126 may store a trained machine learning model that is retrieved and executed by the prioritization system 112 to facilitate generate of notification including a shared link is displayed to a receiving user. For example, the trained machine learning model may predict a user-specific likelihood of engagement with the link. Based on the prediction, a determination of whether to generate the notification, and if so, a type of the communication to generate may be made.

The optional social network graph data store 128 may store the social network graph. The social network graph may include nodes representing each of the link sharing accounts and edges between various nodes that indicate a relationship (e.g., an association or friendship) between the link sharing accounts represented by the nodes connected by the edges. When a receiving user has received multiple links associated with a site, in some examples, the relationships may facilitate prioritization of the links for display in the notification (e.g., when a given prioritization mechanism is a relationship-based mechanism) as described in detail elsewhere herein.

Each of the one or more optional external account provider systems 130 may include one or more server devices (or other similar computing devices) for executing specific account services provided. As previously discussed, the one or more optional external account provider systems 130 may include financial account provider systems providing financial account services. In some examples, when the provider of the link sharing services also provides financial account services (e.g., the provider is a financial institution), at least one of the financial account provider systems may be associated with the provider. Remaining financial account provider systems may be third party providers. In other examples, all of the financial account provider systems may be third party providers.

As described elsewhere herein, the financial account services may include issuing financial accounts to users, such as checking/debit card accounts and credit card accounts, and monitoring activities associated with the financial accounts, including interactions (e.g., transactions or purchases between the users and merchants using the accounts), fund transfers, payments, etc., among other services. Data collected from the monitoring, including interaction data, may be stored over time. In some examples, the merchant interactions forming the interaction data may be stored in conjunction with a timestamp indicating a time period associated with the respective interactions. For users having financial accounts with the financial account provider systems that also have link sharing accounts, the financial account provider systems may provide certain types of financial account information, such as the interaction data, to the link sharing system 110 for use by the validity monitoring system 114 when monitoring for and detecting use of the code, for example. The users may opt in or otherwise provide their consent, permission, or the like to have the interaction data shared with the link sharing system 110.

Additionally or alternatively, the one or more optional external account provider systems 130 may include communication account provider systems providing communication account services. For example, the communication account provider systems may be associated with third party providers. As described in detail elsewhere herein, the communication account services may include sending and receiving communications, such as electronic mail, electronic messages, and/or other similar communications, providing scheduling or calendaring functions, etc. For users having communication accounts with the communication account provider systems that also have link sharing accounts, the communication account provider systems may provide the link sharing system 110 access to the users' communications (e.g., via open authorization (OAuth)) for use by the validity monitoring system 114 in monitoring for and detecting use of the code, for example. The users may opt in or otherwise provide their consent, permission, or the like to have their communications shared with the link sharing system 110.

The one or more optional merchant systems 140 may each include one or more server devices (or other similar computing devices) for executing merchant-related services. Example merchant-related services may include: electronic commerce services to enable users to purchases items of the merchant online via the site of the merchant; referral services to incentivize purchasing users (e.g., sharing users) to refer other users (e.g., receiving users) to purchase products of the merchant in exchange for a bonus, reward, or other similar incentive; and/or tracking services to monitor and update reward statuses for sharing users when one of the referrals has been redeemed. As described in detail elsewhere herein, in some examples, one or more of the optional merchant systems 140 may generate and display a reward notification to the sharing user to indicate how close the sharing user is to obtaining the bonus, reward, or other similar incentive.

The network 106 over which the one or more components of the environment 100 communicate may include one or more wired and/or wireless networks, such as a wide area network (“WAN”), a local area network (“LAN”), personal area network (“PAN”), a cellular network (e.g., a 3G network, a 4G network, a 5G network, etc.) or the like. In some aspects, the network 106 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page”, “webpage”, or “page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. The sharing user computing devices 102, the receiving user computing devices 104, and one or more of the server-side systems 108 may be connected via the network 106, using one or more standard communication protocols. The sharing user computing device 102, the receiving user computing devices 104, and one or more of the server-side systems 108 may transmit and receive communications from each other across the network 106, as discussed in more detail below.

Although depicted as separate components in FIG. 1, it should be understood that a component or portion of a component in the system of exemplary environment 100 may, in some aspects, be integrated with or incorporated into one or more other components. For example, the prioritization system 112 and the validity monitoring system 114 may be integrated with one another and/or one or more other systems of the link sharing system 110. As another example, one or more of the optional external account provider systems 130 and/or one or more of the data storage systems 116 may be integrated with the link sharing system 110 (e.g., to form a larger system of the provider) or the like. In some aspects, operations or aspects of one or more of the components discussed above may be distributed amongst one or more other components. Any suitable arrangement and/or integration of the various systems and devices of the exemplary environment 100 may be used.

In the following disclosure, various acts may be described as performed or executed by a component from FIG. 1, such as the sharing user computing devices 102, the receiving user computing devices 104, or one or more of the server-side systems 108, or components thereof. However, it should be understood that in various aspects, various components of the exemplary environment 100 discussed above may execute instructions or perform acts including the acts discussed below. An act performed by a device may be considered to be performed by a processor, actuator, or the like associated with that device. Further, it should be understood that in various aspects, various steps may be added, omitted, and/or rearranged in any suitable manner.

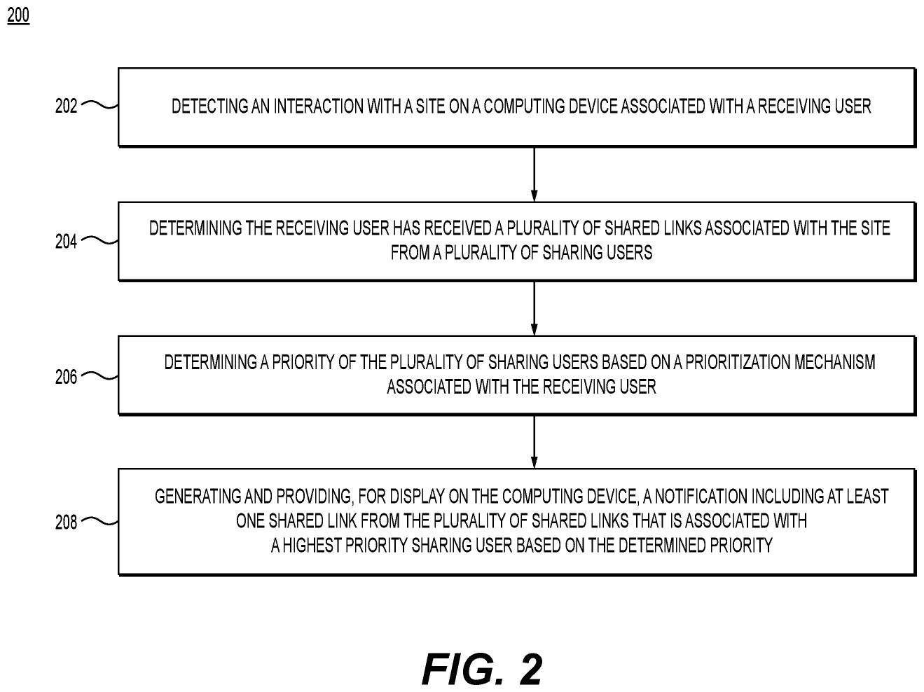

FIG. 2 depicts a flowchart of an exemplary link prioritization process 200, according to certain aspects. In some examples, various steps of the process 200 may be performed by the link sharing system 110, including the prioritization system 112.

At step 202, the process 200 may include detecting an interaction with a site on a computing device associated with a receiving user, such as one of the receiving user computing devices 104. In some examples, the interaction detected may be a navigation to the site via a web browser executing on the receiving user computing device 104. In other examples, the interaction detected may be an inclusion of the site within search results of a search engine executing on the receiving user computing device 104. In further examples, other similar online events that are indicative of potential user interest and/or engagement with the site may be detected as the interaction.

The site may be associated with a merchant (e.g., a merchant associated with one of merchant systems 140). One or more subsystems and/or components of the respective merchant system 140 may execute processes associated with referral, promotional, discount, and/or coupon-related systems that include link generation and monitoring. For example, after a sharing user completes a transaction with the merchant (e.g., via the site), the merchant may generate and provide a link to the sharing user. In some examples, the sharing user may utilize link sharing services of the link sharing system 110 to facilitate the sharing of the link with one or more receiving users, including the receiving user whose computing device the interaction with the site is detected on at step 202.

In some examples, the link may be a referral link. In other examples, the link may be a promotional link, a coupon link, or other similar link. The link may be associated with a code. In some examples, the code may form a portion of the link. For example, the link may include a URL to a page of the merchant site and the code. The code may be used or redeemed to obtain a promotion, offer, discount, or other similar deal from the merchant. As one illustrative example, the merchant may be a home meal delivery service provider. The code associated with the link may be redeemed to get a free week of meals upon purchasing a month subscription. The code may also be associated with the sharing user. For example, the code may be a unique string of characters assigned to the sharing user by the merchant. Such assignment may facilitate a crediting of the sharing user when the code is redeemed by one of the receiving users (e.g., determined based on monitoring performed by the respective merchant system 140 and/or components thereof). For example, the sharing user may receive a bonus, reward, or other similar offer if one or more of the receiving users use the code included in the link shared by the sharing user.

At step 204, the process 200 may include determining the receiving user has received a plurality of shared links associated with the site from a plurality of sharing users. For example, at least the first sharing user and the second sharing user may each have selected to share a link associated with the site with the receiving user. Continuing with the illustrative example, the link shared by each of the first and second sharing users is a link provided by the home meal delivery service provider, and the code associated with the link may be redeemed to get a free week of meals upon purchasing a month subscription.

When the links are shared with the receiving user, the links and/or link information associated with the links may be associated with a link sharing account of the receiving user in one or more data stores. For example, the links and/or link information may be stored in the account information data store 120 in association with the link sharing account of the receiving user (e.g., within a listing of links having been received by the receiving user). In some examples, a determination that the receiving user has received more than one link associated with the site may be identified based on a common portion of the link within the listing. For example, the common portion may be a domain name included in the URL portion of the link. Additionally, in some examples, an indicator of the referral, promotion, or deal may be included within a portion of the link comprising the code (e.g., save100), and the common portion may include the domain name and/or the indicator.

Typically, a merchant may restrict or limit a number of referrals, promotions, or deals that a consumer can redeem or apply. For example, if the consumer has two referrals for 50% of a purchase of an item, the consumer may only apply one. Therefore, when the receiving user is determined to have received more than one link associated with the site, prioritizing among links received by the receiving user based on a priority of the associated sharing users, as described in detail with respect to step 206, may facilitate the receiving user's determination of which link to use to redeem the referral, promotion, or deal.

At step 206, the process 200 may include determining a priority of the plurality of sharing users based on a prioritization mechanism associated with the receiving user. The prioritization mechanism may be alternatively referred to as a deconflicting mechanism as the mechanism serves to deconflict among the shared links. In some examples, the prioritization mechanism may be selected by the receiving user as a preference or setting for the link sharing account. In other examples, the prioritization mechanism may be a default prioritization mechanism (e.g., if the user has not selected a different mechanism from the default).

In some examples, the prioritization mechanism may include prioritizing among sharing users based on one or more criteria associated with the sharing users. For example, the selected prioritization may be to show links from a sharing user having x criteria. As one example, the criteria may be assignment of the sharing user to a priority group by the receiving user. For example, the sharing user may be a friend or associate of the receiving user that is assigned to the priority group (e.g., assigned to a friend group, a connection group etc.). As previously discussed, the priority group and any other relationships of the receiving user may be maintained by a social network graph (e.g., stored in the optional social network graph data store 128). Additionally or alternatively, assignment of the sharing user to the priority group may be determined based on a list of sharing users defined by the receiving users.

As another example, sharing users having engaged with links shared by the receiving user may be prioritized (e.g., to promote reciprocation). Various levels of engagement with the links may be monitored, and different weights may be given to the various levels. For example, a first weight may be associated with a selection of a link shared by the receiving user, and a second weight greater than the first weight may be associated with a redemption of a code associated with the link shared by the receiving user.

As a further example, sharing users having shared a threshold number of links with the receiving user, sharing users most recently sharing links with the receiving user, and/or sharing users least recently sharing links with the receiving user may be prioritized. In some examples, link sharing information may be a subset of information stored in association with a link sharing account of the receiving user within the account information data store 120. To provide an illustrative example, when a sharing user shares a link with the receiving user, a data entry for the link is generated and stored in association with the link sharing account of the receiving user within account information data store 120. The data entry includes a plurality of data fields. The data fields may include an identifier of the sharing user who shared the link, and a time associated with the sharing of the link. These data fields may be referenced (e.g., queried) by the prioritization system 112 when performing the prioritization based on number and/or recency of links shared by sharing users with the receiving user.

As a yet further example, sharing users closest to obtaining a reward from the merchant may be prioritized. In some examples reward-related information may be a subset of information stored in association with a link sharing account of the sharing user within account information data store 120 (or optionally a separate reward status data store). To provide an illustrative example, the merchant may provide a sharing user with a reward after three referrals have been redeemed. Each time a referral is redeemed (each time a code associated with a shared link is applied), a data field for reward count may be incremented in a data entry for the shared link. Another data field in the data entry for the shared link may indicate a total number of referrals that need to be redeemed to obtain the reward (e.g., three). These data fields may be referenced (e.g., queried) by the prioritization system 112 when performing the prioritization based on the sharing users closest to obtaining a reward from the merchant.

The above examples for prioritization mechanisms are non-exhaustive and non-limiting. Other criteria associated with the sharing users may be utilized by the prioritization mechanism. In other examples, the prioritization mechanism may include alternating priority among sharing users (e.g., a round robin prioritization approach).

In some examples, the link sharing system 110 may provide muting features to enable a receiving user to mute a particular sharing user and/or mute a particular sharing user for a predefined amount of time to prevent saturation. Such muting may prevent any links shared by that muted sharing user from being presented to the receiving users. The muting features may be used in conjunction with the prioritization mechanism for determining the priority at step 206. For example, when a link shared by a muted sharing user is received by the receiving user, that link is determined to be of lowest priority and not to be presented to the receiving user, even if the prioritization mechanism would otherwise determine the link to be of high priority.

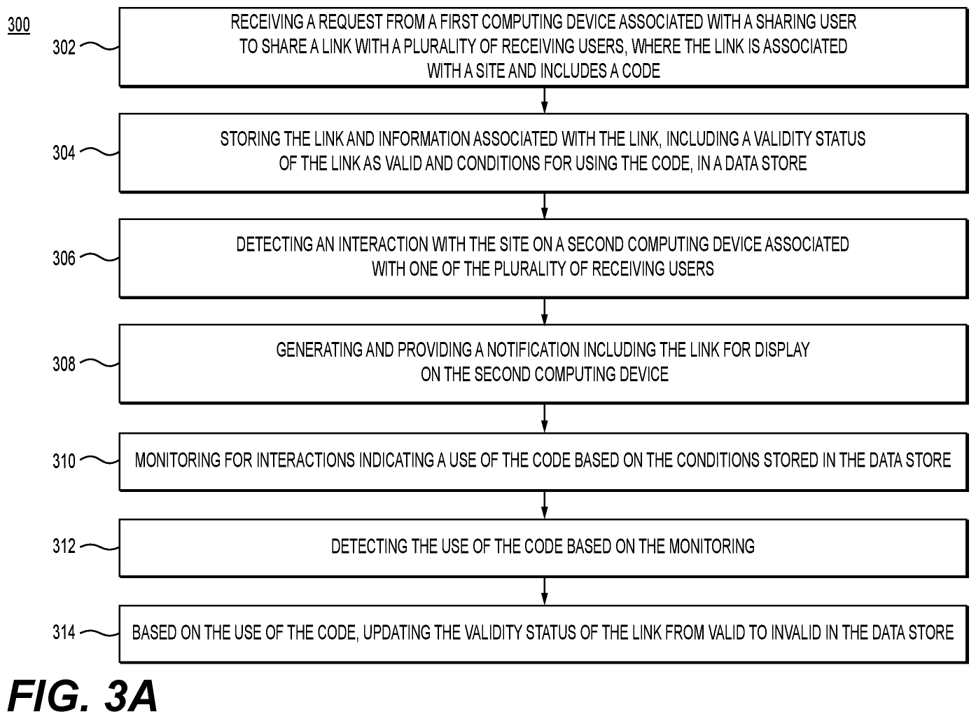

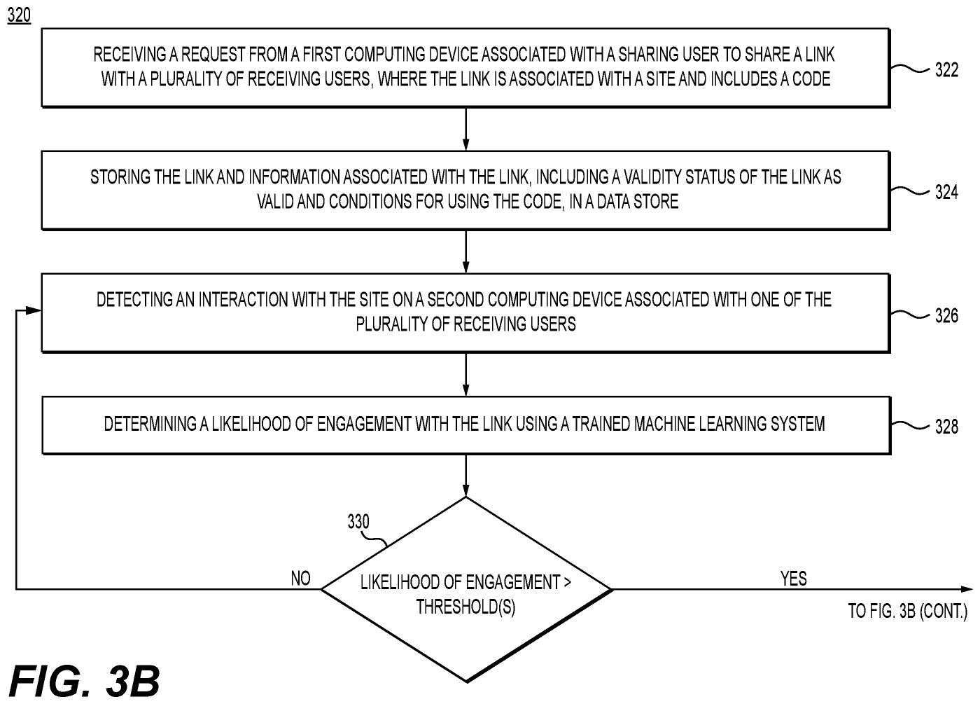

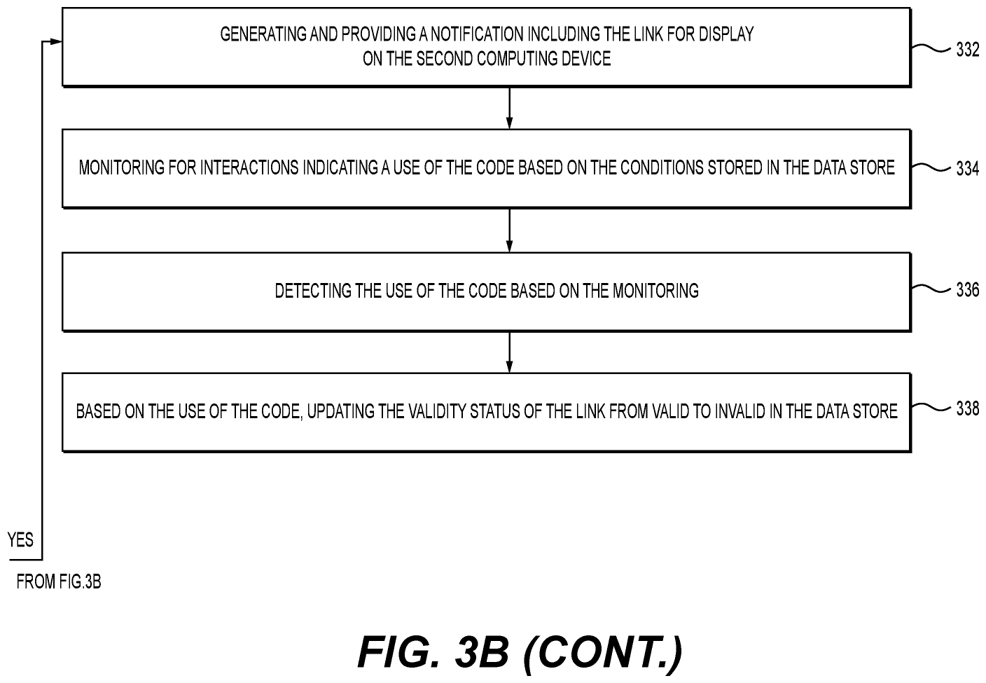

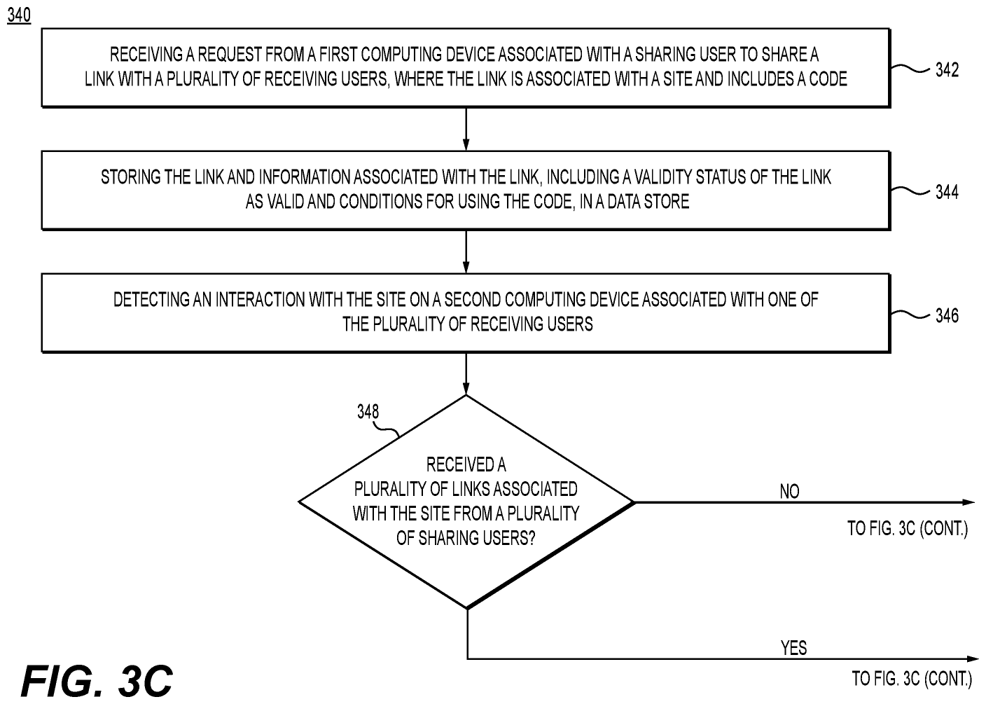

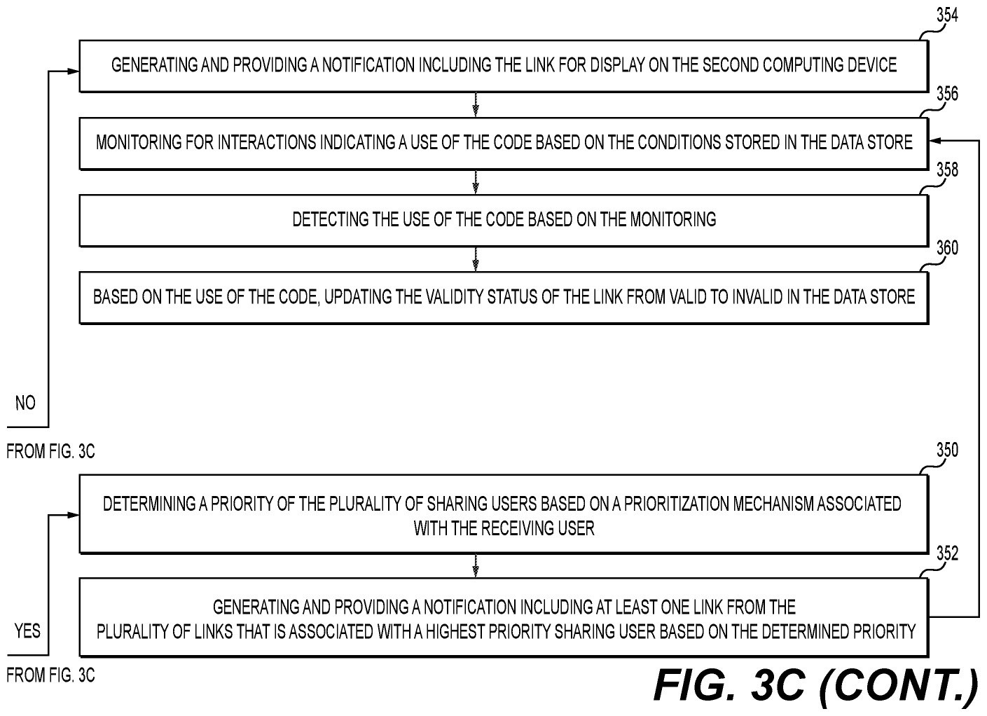

Additionally, at step 206, the priority may be determined for only a subset of the plurality of users corresponding to a subset of the plurality of links that are identified as valid. As one example, the validity monitoring data store 124 may be queried for a validity status of each link stored by the validity monitoring data store 124. The validity status for a given link may be valid or invalid based on whether a respective code associated with the given link is still capable of being redeemed (e.g., whether the respective code has expired). As discussed in greater detail with reference to FIGS. 3A-3C, the validity status may be monitored and updated from valid to invalid by the validity monitoring system 114. In some examples each of the shared links may be identified as valid. In other examples, only a subset of the shared links may be determined as valid. As another example, when a shared link is updated from valid to invalid by the validity monitoring system 114, the shared link may be automatically removed from the listing of links having been received by the receiving user in the account information data store 120. In such examples, the determination of the plurality of shared links received at step 204 would not include any invalid links, and thus the priority of each of the plurality of users may be determined at step 206.

At step 208, the process 200 may include generating and providing, for display on the computing device (e.g., the receiving user computing device 104), a notification. The notification may include at least one shared link from the subset that is associated with a highest priority sharing user based on the determined priority. In some examples, multiple shared links from the subset may be displayed, where the shared links may be positioned, ordered, or otherwise emphasized within the notification based on the determined priority. For example, when the first sharing user is determined to have a higher priority than the second sharing user, a first link shared by the first sharing user may be displayed at a top of the notification, followed by a second link shared by the second sharing to visually indicate the priority.

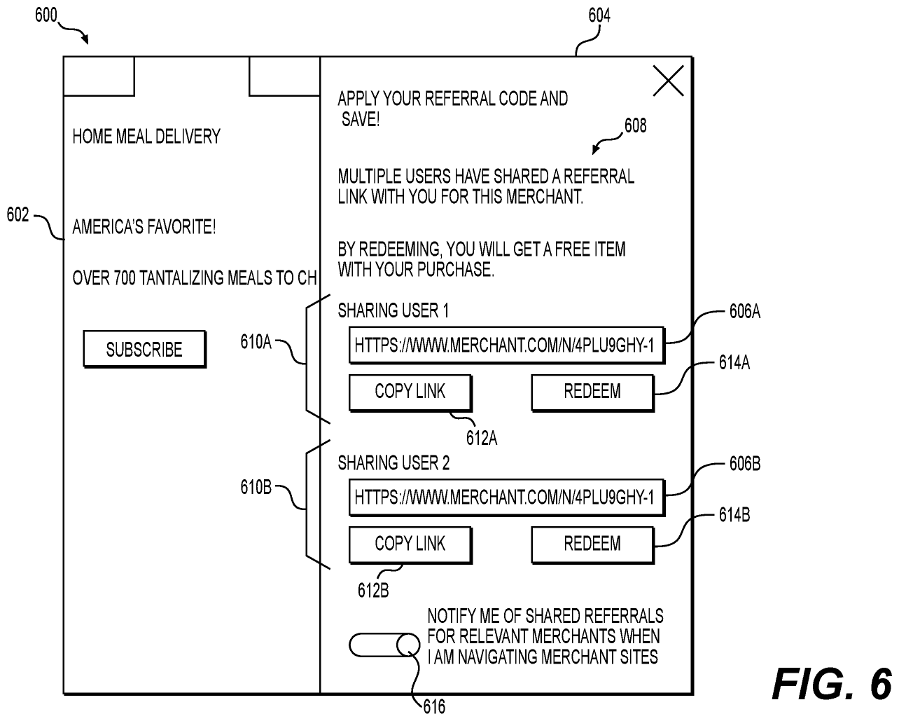

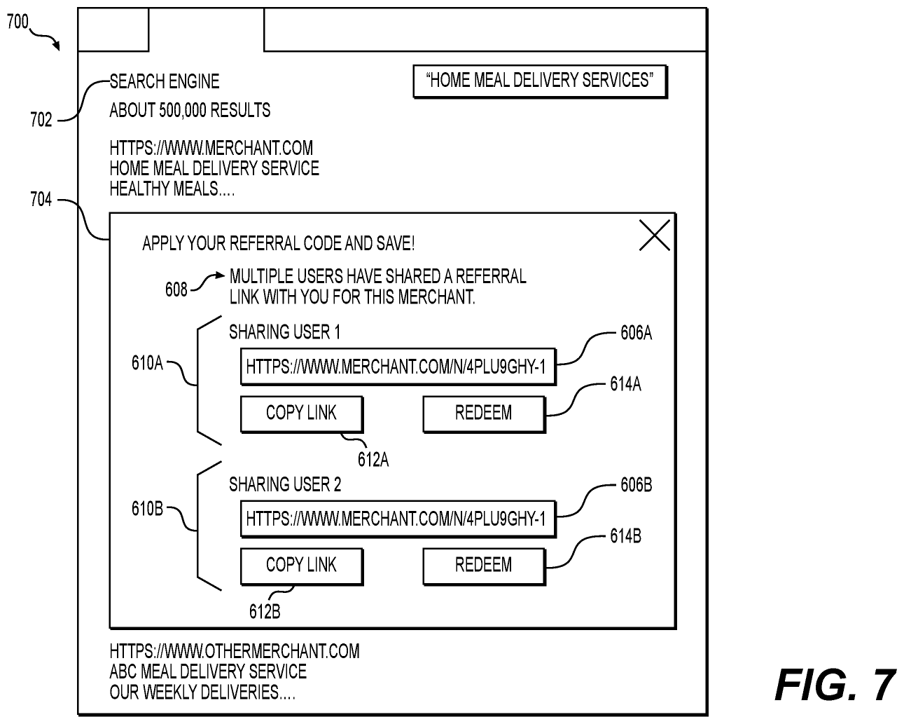

In some examples, a type of the notification generated and displayed at step 208 may be based on the type of the interaction with the site detected at step 202. For example, when the interaction detected is the navigation to the site via the web browser executing on one of the receiving user computing devices 104, the notification may be a push notification displayed via the web browser, such as the exemplary notification shown in FIG. 6. As another example, when the interaction detected is the inclusion of the site within search results of a search engine executing on one of the receiving user computing devices 104, the notification may be embedded within the search results in association with site, such as the exemplary notification shown in FIG. 7.

Upon providing the notification for display, the link sharing system 110 may be configured to monitor for interactions with one or more of the links included in the notification, including use or redemption of a code associated with a respective link as described in detail with reference to FIGS. 3A-3C.

Accordingly, certain aspects of the systems and methods described herein may perform link prioritization processes. The process 200 described above is provided merely as an example, and may include additional, fewer, different, or differently arranged steps than depicted in FIG. 2.

FIG. 3A depicts a flowchart of an exemplary process 300 for monitoring a validity of a shared link, according to certain aspects. In some examples, various steps of the process 300 may be performed by the link sharing system 110, including the validity monitoring system 114.

At step 302, the process 300 may include receiving a request from a first computing device associated with a sharing user (e.g., one of sharing user computing devices 102) to share a link with a plurality of receiving users, including the first receiving user and/or the second receiving user, for example. The link may be associated with a site and include a code. For example, the link may be provided by a merchant associated with the site. In some examples, the link may be a referral link. In other examples, the link may be a promotional link, a coupon link, or other similar link. In some examples, the code may form a portion of the link. For example, the link may include a URL to a page of the site and the code. The code may be used or redeemed to obtain a promotion, offer, discount, or other similar deal from the merchant. The code may also be associated with the sharing user. For example, the code may be a unique string of characters assigned to the sharing user to enable the sharing user to receive a bonus, reward, or other similar offer if the code is redeemed. For purposes of the process 300, the code may be non-reusable (e.g., a one-time use code) or a number of uses of the code may be limited.

At step 304, the process 300 may include storing the link and information associated with the link, including a validity status of the link as valid and conditions for using the code, in a data store, such as validity monitoring data store 124. For example, the validity monitoring data store 124 may store a data entry for the link. The data entry may include a plurality of data fields, including at least a data field for the link, a validity status data field, and a data field for each of one or more conditions for using the code. The value of the validity status data field may indicate whether the link is valid or invalid. A link may be indicated as valid when the link is still capable of being redeemed or used. A link may be indicated as invalid (e.g., expired) if the link is no longer capable of being redeemed. For example, if the code associated with the link is a one-time use code, the link will be invalid after the one-time use code is redeemed by one of the receiving users. As another example, if the code is a limited use code that can be redeemed five times, the link will be invalid after the limited use code is redeemed by five of the receiving users.

The conditions for using the code may define interactions to be performed in order to use the code. For example, the conditions may represent steps for completing a referral. The interactions may be monitored for by the validity monitoring system 114 in conjunction with the link sharing application executing on the receiving users computing devices 104. One example condition may include detecting a selection of the link, for example, from a notification displayed on a web browser executing on one of the receiving user computing devices 104, such as the notification described with reference to FIG. 2. Another example condition may include detecting a loading of the URL included in the link on the web browser (e.g., a URL directing to a particular page of the merchant's site). The loading of the URL may occur after the receiving user has selected the link. A further example condition may include detecting a loading of another URL associated with the site that indicates a qualifying interaction occurred between the receiving user and the merchant to enable the receiving user to use or redeem the code associated with the link. An example qualifying interaction may be a transaction generally, a transaction including a particular item, a transaction of a particular value, a creation of an account with the merchant, and/or other similar interaction. When the qualifying interaction is transaction related, the other URL loaded may be associated with a checkout page of the merchant's site, for example. When the qualifying interaction is account generation related, the other URL loaded may be associated with an account generation page of the merchant's site, for example.

The value of the data field for each of one or more conditions may indicate whether the respective interaction defined by the condition for using the code has occurred. Initially, a value of the data field for each of one or more conditions may be null. As described in detail below, the value may then be updated to indicate the respective condition has occurred upon the detection of the respective condition.

At step 306, the process 300 may include detecting an interaction with the site on a second computing device associated with the one of the plurality of receiving users (e.g., on one of the receiving user computing devices 104). In some examples, the interaction detected may be a navigation to the site via a web browser executing on one of the receiving user computing devices 104. In other examples, the interaction detected may be search results of a search engine executing on one of the receiving user computing devices 104 including the site. Other similar online events that are indicative of potential user interest and/or engagement with the site may be detected.

At step 308, the process 300 may include generating and providing a notification including the link for display on the second computing device. In some examples, a type of the notification generated and displayed at step 308 may be based on the type of the interaction with the site detected at step 306. For example, when the interaction detected is the navigation to the site via the web browser executing on one of the receiving user computing devices 104, the notification may be a push notification displayed via the web browser, such as the exemplary notification shown in FIG. 6. As another example, when the interaction detected is the inclusion of the site within search results of a search engine executing on one of the receiving user computing devices 104, the notification may be embedded within the search results in association with site, such as the exemplary notification shown in FIG. 7. In other examples, the type of the notification generated and displayed at step 308 may be based on account settings and/or preferences of the receiving user (e.g., included in profile information for the receiving user's link sharing account received from the account profile data store 118).

At step 310, the process 300 may include monitoring for interactions indicating a use of the code based on the conditions stored in the data store. The interactions monitored for may include the interactions defined by the conditions. For example, and as described above in more detail with respect to step 304, interactions monitored for may include a selection of the link, a loading of a first page of the site on the computing device responsive to the selection of the link, and/or a loading of a second page of the site on the computing that is associated with an interaction indicating the use of the code (e.g., a completed checkout page of the site, a loaded completed account generation page of the site, etc.). In some examples, the monitoring process implemented by the validity monitoring system 114 may be based on a plurality of rules. In other examples, one or more machine learning models may be trained and implemented to perform the monitoring. The monitoring may be performed in conjunction with the link sharing application executing on the second computing device.

Other example interactions that may be optionally monitored for include at least one communication associated with the site that indicates the use of the code that is received by a communication account associated with the receiving user. For example, a plurality of communications received by the communication account associated with the receiving user may be accessed by the validity monitoring system 114 and parsed to identify the at least one communication associated with the site that indicates the use of the code. For example, communication account provider systems (e.g., one of external account provider systems 130) of one or more of the receiving users may provide the link sharing system 110 access to the users' communications (e.g., via OAuth) for use by the validity monitoring system 114. The communications may then be parsed to, for example, identify any transaction receipts from the merchant generally, transaction receipts from the merchant including a particular item, transaction receipts from the merchant of a particular value, and/or account generation confirmations from the merchant corresponding to one of the conditions for use of the code.

As each condition for use of the code is detected based on the monitored interactions, the value of the data field for the respective condition in the data entry for the link may be updated within the validity monitoring data store 124 to reflect the condition has been met (e.g., the value may be updated from null).

At step 312, the process 300 may include detecting the use of the code based on the monitoring. For example, once each of the conditions are determined to have been met based on the monitoring (e.g., the link has been selected, a first page of the site has loaded responsive to the selection of the link, and/or a second page of the site associated with a qualifying interaction for code use has loaded), the code may be detected as having been used or redeemed. As one example, the detection of use may be based on a determination that the data field for each condition included in the data entry for the link within the validity monitoring data store 124 has been updated (e.g., no condition data fields remain null).

At step 314, the process 300 may include updating the validity status of the link from valid to invalid in the data store (e.g., the validity monitoring data store 124) based on the use of the code. For example, the value within the validity status data field of the data entry for the link stored within the validity monitoring data store 124 may be updated to indicate the link is now invalid. The updating of the validity status of the link to invalid may prevent the link from being displayed to any other receiving users whom the sharing user shared the link with when an interaction with the site is detected on one or more computing devices associated with the other receiving users. As one example, the validity monitoring data store 124 may be queried to determine the link's validity status prior to displaying the link to any of the other receiving users. As another example, when the link is updated from valid to invalid, the link may be automatically removed from the listings of links having been received by the other receiving users that are stored in the account information data store 120 in association with the other receiving users.

As previously discussed, for purposes of the process 300, the code may be non-reusable (e.g., a one-time use code) or a number of uses of the code may be limited. In some examples, the data entry for the link may include a first data field indicating a number of allotted uses of the code, and a second data field that is incremented each time a use is detected (e.g., at step 312). The first and second data fields may then be compared as part of step 314 to determine whether the number of allotted uses has been met. When the number of allotted uses has been met, the validity status may be updated.

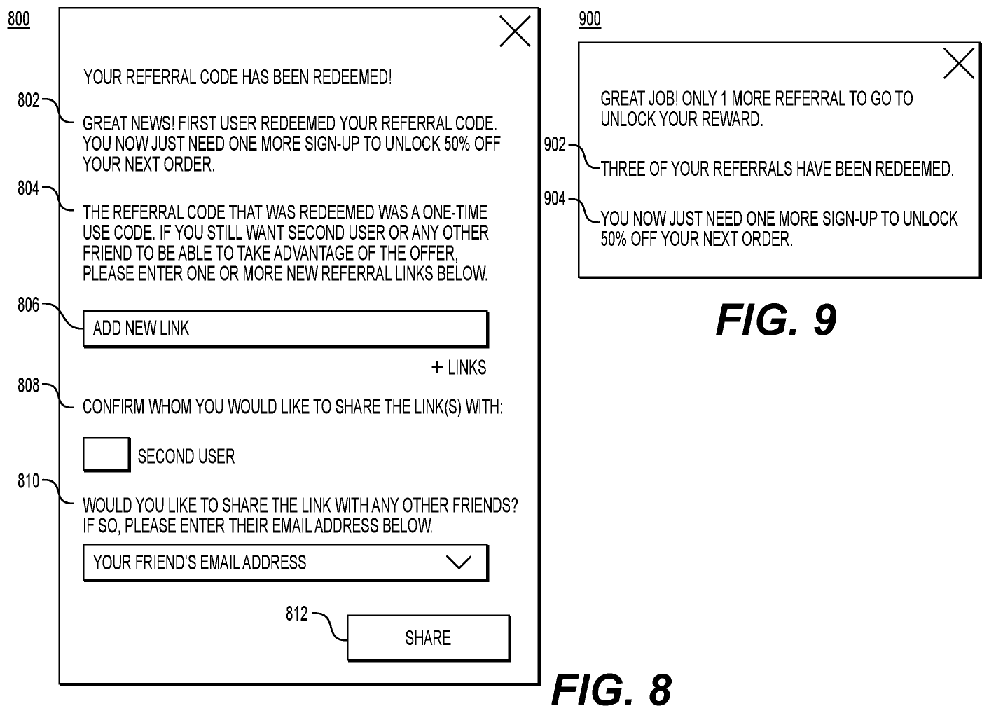

In some examples, the updating of the validity status of the link to invalid may also cause a use notification to be generated and provided to the first computing device associated with the sharing user (e.g., one of the sharing user computing devices 102). The use notification may indicate the use and prompt the sharing user to provide one or more new links associated with the site to share with the one or more other receiving users they initially selected to share the link with and/or one or more new receiving users. In such examples, when one or more new links are received and distributed to the computing devices of the one or more of the other receiving users, the new links may replace the links originally distributed. An exemplary use notification is shown in FIG. 8.

As previously discussed, the sharing user may receive a bonus, reward, or other similar incentive from the merchant when a predefined number of codes (e.g., one or more codes) of shared links associated with the merchant have been used or redeemed. To facilitate tracking, when the code is used, the unique string of characters within the code that is assigned to the sharing user by the merchant may be used by the respective merchant system 140 to identify and credit the sharing user with one redeemed code (e.g., a redeemed referral). In some examples, a reward notification may be generated and provided by the merchant system 140 to the sharing user to indicate how close the sharing user is toward obtaining the bonus, reward, or other similar incentive. The notification may include a first number of codes that have been used or redeemed and/or a second number of codes that still need to be used or redeemed in order for the sharing user to obtain the bonus, reward, or other similar incentive. An exemplary reward notification is shown in FIG. 9.

Additionally, the validity monitoring system 114 may track use of codes and the reward status of the sharing user independently from the merchant system 140. For example, to facilitate tracking, when the use of the code is detected at step 312 and the validity status of the link is updated at step 314, a number of used codes stored in association with the sharing user in the account information data store 120 (or optionally a separate rewards data store) may be incremented by one. In some examples, when the reward notification is provided to the sharing user by the merchant system 140, the link sharing application may identify, extract, and provide the first number of codes from the notification to the validity monitoring system 114 for comparison with the number of used codes stored in association with the sharing user in the account information data store 120.

In some examples, if the first number of codes does not match the number of used codes stored, the number of used codes stored may be updated to reflect the first number of codes. For example, a mismatch may occur when the sharing user had shared a first link associated with the merchant that was redeemed prior to the sharing user generating a link sharing account with the link sharing system 110. Additionally, when there is mismatch, and particularly when the number of used codes stored is greater than the first number of codes provided by the merchant, a predefined threshold of time from a last code use may elapse prior to the updating the number of used codes stored in the account information data store 120 to account for any potential lag in the merchant system 140.

FIG. 3B depicts a flowchart of another exemplary process 320 for monitoring a validity of a shared link, according to certain aspects. In some examples, various steps of the process 320 may be performed by the link sharing system 110, including the prioritization system 112 and/or the validity monitoring system 114.

Process 320 may include similar steps to steps of the process 300. Specifically, steps 322, 324, and 326 of the process 320 may correspond respectively to steps 302, 304, and 306 of the process 300, as described in detail above with reference to FIG. 3A. For example, at step 322, a request may be received from a first computing device associated with a sharing user (e.g., one of the sharing user computing devices 102) to share a link with a plurality of receiving users, where the link is associated with a site and includes a code. At step 324, the link and information associated with the link, including a validity status of the link as valid and conditions for using the code, may be stored in a data store, such as the validity monitoring data store 124. At step 326, an interaction with the site may be detected on a second computing device associated with one of the plurality of receiving users (e.g., one of the receiving user computing devices 104).

At step 328, the process 320 may include determining a likelihood of engagement with the link using a trained machine learning system. For example, historical shared link engagement data associated with the receiving user may be received from the historical link engagement data store 122 and/or directly from the account information data store 120. The historical shared link engagement data may include, for each historical shared link that had been displayed on any computing device associated with the receiving user, information associated with the respective historical shared link and a level of engagement with the respective historical shared link. The information associated with the respective historical shared link may include a merchant that provided the link, an item associated with the link, an offer associated with the link, a sharing user that shared the link, and/or a context in which the shared link was presented to the user (e.g., a push notification in the web browser upon user navigation to the merchant site, within search results, in electronic communications, etc.), among other similar information. The level of engagement may indicate whether the historical shared link was selected (e.g., clicked on), whether a code associated with the historical shared link was used or redeemed, etc.

The historical shared link engagement data may be provided as input to a trained machine learning model of the machine learning system along with information associated with the link. The information associated with the link may include the merchant that provided the link, an item associated with the link, an offer associated with the link, a sharing user that shared the link, and/or a type of interaction with the site. A predicted likelihood of engagement with the link may be received as output of the trained machine learning model. For example, the trained machine learning model may be trained to predict the likelihood of the receiving user's engagement with this particular link (given the information associated with the link) based on the receiving user's past engagement behavior with links (given the historical shared link engagement data).

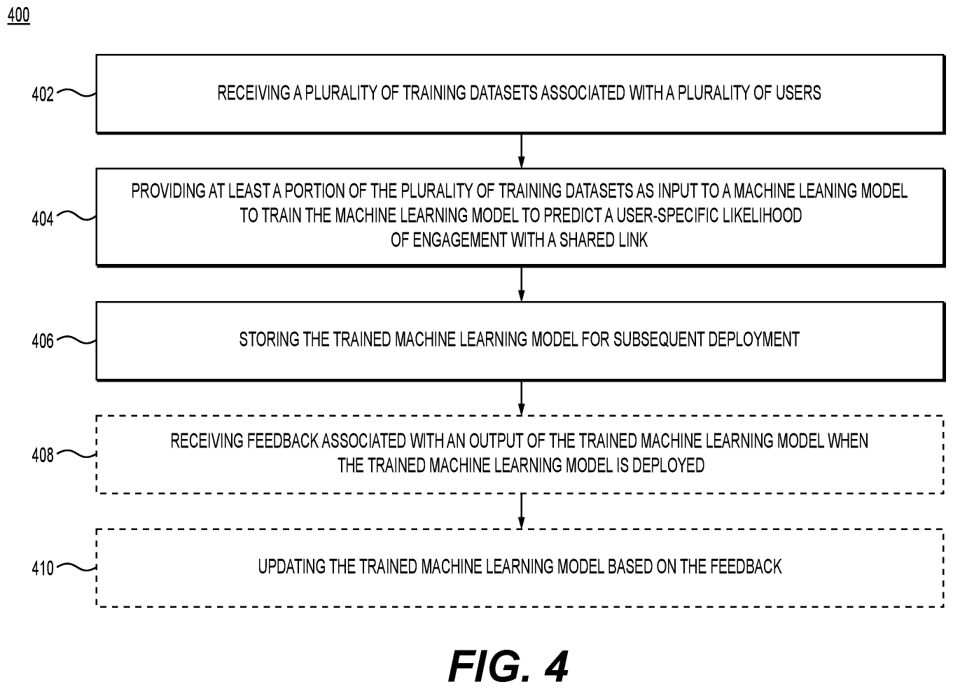

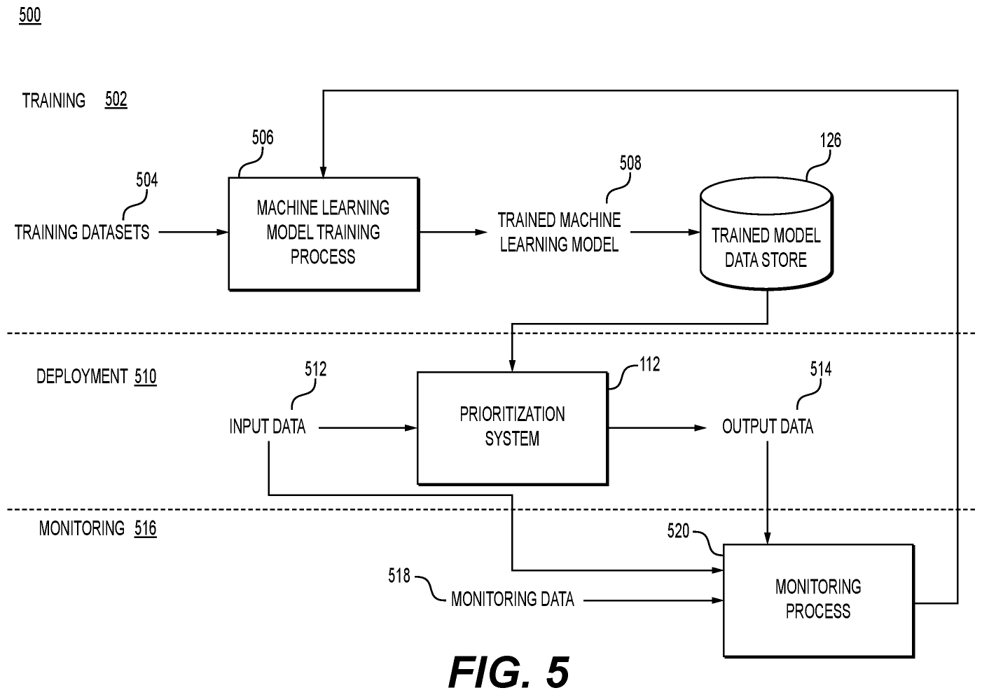

In some examples, the output may be a binary decision (e.g., yes or no, engagement or nonengagement, etc.). For example, the output of the trained machine learning model may be a probability (from 0 to 1) that the receiving user will engage with the code. A predefined threshold can then be applied to yield the binary decision of yes, the receiving user will engage, or no the receiving user will not. For example, if the predefined threshold is 0.5, a probability less than 0.5 yields a prediction of no, and a probability equal to or greater than 0.5 yields a prediction of yes. Training, use, and/or monitoring of the model is described in greater detail below, with reference to FIGS. 4 and 5.

At step 330, the process 320 may include a determination of whether the likelihood of engagement meets (e.g., is at or above) one or more predefined threshold(s). In some examples, the thresholds may be associated with different types of contextual engagement. For example, whether the user is likely to interact with the link when the link is displayed within a push notification when interacting with the site versus within search results including the site, among other contexts. If at step 330, a determination is made that the likelihood of engagement does not meet the one or more predefined threshold(s), the process 320 may return to 326. Otherwise, if at step 330, a determination is made that the likelihood of engagement does meet the one or more predefined threshold(s), the process 320 may proceed to one or more of steps 332-338.

Steps 332, 334, 336, and 338 of the process 320 may correspond respectively to steps 308, 310,312, and 314 of the process 300, as described in detail above with reference to FIG. 3A. For example, at step 332, a notification including the link may be generated and provided for display on the second computing device. In some examples, based on the thresholds determined to be met, the notification may be provided in response to a certain type of interaction detected on the second computing. For example, the notification may be provided within search results that include the site, but not in response to detecting a navigation to the site or vice versa. At step 334, interactions indicating a use of the code based on the conditions stored in the data store may be monitored for. At step 336, the use of the code may be detected based on the monitoring. At step 338, the validity status of the link may be updated from valid to invalid in the data store based on the use of the code.

FIG. 3C depicts a flowchart of a further exemplary process 340 for monitoring a validity of a shared link, according to certain aspects. In some examples, various steps of the process 340 may be performed by the link sharing system 110, including the prioritization system 112 and/or the validity monitoring system 114.

The process 340 may include similar steps to steps of the process 300. Specifically, steps 342, 344, and 346 of the process 340 may correspond respectively to steps 302, 304, and 306 of the process 300, as described in detail above with reference to FIG. 3A. For example, at step 342, a request may be received from a first computing device associated with a sharing user (e.g., one of the sharing user computing devices 102) to share a link with a plurality of receiving users, where the link is associated with a site and includes a code. At step 344, the link and information associated with the link, including a validity status of the link as valid and conditions for using the code, may be stored in a data store, such as the validity monitoring data store 124. At step 346, an interaction with the site may be detected on a second computing device associated with one of the plurality of receiving users (e.g., one of the receiving user computing devices 104).

At step 348, the process 340 may include determining whether the one of the plurality of receiving users has received a plurality of links associated with the site from a plurality of sharing users. The determination process may be the same or similar as the determination process described above with reference to step 204 of process 200 of FIG. 2.

If at step 348, a determination is made that the one of the plurality of receiving users has not received a plurality of links associated with the site, the process 340 may proceed to one or more of steps 354-360. Steps 354, 356, 358 and 360 of the process 340 may correspond respectively to steps 308, 310, 312, and 314 of the process 300, as described in detail above with reference to FIG. 3A. For example, at step 354, a notification including the link may be generated and provided for display on the second computing device. At step 356, interactions indicating a use of the code based on the conditions stored in the data store may be monitored for. At step 358, the use of the code may be detected based on the monitoring. At step 360, the validity status of the link may be updated from valid to invalid in the data store based on the use of the code.

Alternatively, if at step 348, a determination is made that the one of the plurality of receiving users has received a plurality of links, the process 340 may proceed to steps 350 and 352. At step 350, the process 340 may include determining a priority of the plurality of sharing users based on a prioritization mechanism associated with the receiving user. At step 352, the process 340 may include generating and providing a notification including at least one link from the plurality of links that is associated with a highest priority sharing user based on the determined priority at step 350. The priority determination and notification generation may be the same or similar processes as described above with reference to steps 206 and 208, respectively, of the process 200 of FIG. 2. The process 340 may then proceed to steps 356, 358, and 360, where the code use being monitored for and detected is the code associated with the at least one link included in the notification at step 352.

Accordingly, certain aspects of the systems and methods described herein may include monitoring for a validity of shared links. The processes 300, 320, and 340 described above are provided merely as examples, and may include additional, fewer, different, or differently arranged steps than depicted in FIGS. 3A-3C. For example, processes 320 and 340 may be combined such that after a determination is made at step 330 of process 320 that the likelihood of engagement with the link does meet the one or more predefined threshold(s), the process may proceed step 348 of process 340 to determine whether the receiving user has received the plurality of links associated with the site.

FIG. 4 depicts a flowchart of an exemplary process 400 for training a machine learning model to predict a user-specific likelihood of engagement with a shared link, according to certain aspects. The process 400 is provided merely as an example, and can include additional, fewer, different, or differently arranged aspects than depicted in FIG. 4. In some examples, the process 400 may be performed by the link sharing system 110 and/or the prioritization system 112. In other examples, the process 400 may be performed by another system or device (e.g., of a third party). The trained machine learning model may then be provided to and executed by the prioritization system 112 for deployment. In some examples, the trained machine learning model may be monitored upon deployment and updated and/or re-trained based on the monitoring to improve an accuracy of the machine learning mode. FIG. 5 is a diagram 500 conceptually showing an example of a process for training 502, deployment 510, and monitoring 516 of the machine learning model, according to certain aspects.

Referring concurrently to FIGS. 4 and 5, at step 402, the process 400 may include receiving a plurality of training datasets 504 associated with a plurality of users. The plurality of users may each have link sharing accounts with the link sharing system 110. Each of the plurality of training datasets 504 may be associated with a shared link received by a respective user in the past. Therefore, two or more of the training datasets 504 may be associated with a same user of the plurality users if the user has received two or more shared links in the past. An exemplary training dataset 504 associated with a shared link received by a respective user may include a browsing history and/or browsing pattern of the user, code information associated with the link (e.g., a type of item, a type of offer, deal, or promotion, etc.), merchant information associated with the link, a sharing user of the link, and/or context of a presentation of the link (e.g., a push notification in the web browser upon user navigation to the merchant site, within search results, in electronic communications, etc.). The training dataset 504 may also include a label that indicates whether the respective user actually engaged with the shared link (e.g., a label of 1 if used or 0 if did not). Engagement may include at least a selection of the link, causing navigation to a page of a site of an associated merchant indicated by the URL included in the link.

At step 404, process 400 may include providing at least a portion of the plurality of training datasets 504 as input to a machine learning model 508 to train the machine learning model 508 to predict a user-specific likelihood of engagement with the link. For example, the machine learning model 508 may be trained to solve a classification problem (e.g., whether a given user will engage with a link or not). For training 502, the training datasets 504 are provided as inputs to a machine learning model training process 506 to generate (e.g., build) the machine learning model 508. Generally, a model includes a set of variables, e.g., nodes, neurons, filters, etc., that are tuned, e.g., weighted or biased, to different values via the application of the training datasets 504.

In some examples, the machine learning model training process 506 employs supervised learning processes to train the machine learning model 508. When supervised learning processes are employed, labels or scores, such as the above-described label that indicates whether the respective user actually engaged with the shared link, facilitate the learning process by providing a ground truth. Training proceeds by feeding the inputs from one of the training datasets 504 associated with a receiving user who had previously received a shared link from a sharing user into the model, the model having variables set at initialized values, e.g., at random, based on Gaussian noise, a pre-trained model, or the like. The model outputs a predicted yes (1) or no (0) of whether the respective receiving user will engage with the shared link for the sample (e.g., outputs a prediction of engagement or nonengagement). In some examples, the output may be a probability (from 0 to 1) that the receiving user will engage with the code, and a predefined threshold can then be applied to yield the binary decision of yes, the receiving user will engage, or no the receiving user will not. The output is compared with the corresponding label for the training dataset 504 (e.g., the ground truth) that indicates whether the respective user actually engaged with the shared link to determine an error, which is then back-propagated through the model to adjust the values of the variables. This process is repeated for a plurality of samples (e.g., at least the portion of the plurality of the training datasets 504) at least until a determined loss or error is below a predefined threshold. In some examples, the other portion of the training datasets 504 that are withheld are then utilized to test and/or validate the first machine learning model.

In other examples, unsupervised, semi-supervised, and/or reinforcement learning processes can be used to train the machine learning model 508. For unsupervised learning processes, the training datasets 504 do not include pre-assigned labels or scores to aid the learning process. Rather, unsupervised learning processes include clustering, classification, or the like to identify naturally occurring patterns in the training datasets 504. Supervised or unsupervised K-means clustering or K-Nearest Neighbors can also be used. Combinations of K-Nearest Neighbors and an unsupervised cluster technique can also be used. For semi-supervised learning, a combination of the training datasets 504 with pre-assigned labels or scores and similar training datasets without pre-assigned labels or scores are used to train the model. When reinforcement learning is employed, an agent (e.g., an algorithm) is trained to make a decision regarding the respective user engaging or not with the shared link for the sample from the training datasets 504 through trial and error. For example, upon making a decision, the agent then receives feedback (e.g., a positive reward if the predicted engagement or non-engagement aligns with feedback), adjust its next decision to maximize the reward, and repeat until a loss function is optimized.

In some examples, the trained machine learning model 508 generated may be common to the plurality of users. In other examples, one or more separate, user-specific trained machine learning model may be generated for one or more of the plurality of users (e.g., when sufficient training data is available for the users).

Once trained, at step 406, the process 400 may include storing the trained machine learning model 508 for subsequent deployment. For example, the trained machine learning model 508 may be stored in the trained model data store 126. The trained machine learning model 508 may then be retrieved from the trained model data store 126 and subsequently deployed (e.g., executed) by the prioritization system 112 to perform aspects of process 320, for example. In some examples, the trained machine learning model 508 may be retrieved after a link associated with a merchant has been shared with a receiving user by a sharing user, and an interaction with the site of the merchant is detected on the receiving user computing device 104 of the receiving user.

During the deployment 510 of the trained machine learning model 508, the prioritization system 112 may execute the trained machine learning model 508 to perform at least step 328 of the process 320, as described above in detail with reference to FIG. 3B. Briefly, the historical shared link engagement data for the receiving user whose likelihood of engagement is being determined may be provided, along with information associated with the link, as input data 512 to the trained machine learning model 508. In examples where a separate, user-specific machine learning model is generated for the receiving user, the information associated with the link may be provided as the input data 512. The trained machine learning model 508 may then output a prediction of engagement or nonengagement with the link as output data 514.

At optional step 408, process 400 may include receiving feedback associated with an output of the trained machine learning model 508 (e.g., with the output data 514) when the trained machine learning model 508 is deployed. For example, the output data 514 of the trained machine learning model 508 may predict engagement with the link by a respective receiving user. During the monitoring 516 of the trained machine learning model 508, an indication of whether or not the respective receiving user actually engaged with the link or not may be collected as feedback and used as monitoring data. As part of a monitoring process 520, the monitoring data 518 may then be analyzed along with the input data 512 and the output data 514 to determine an accuracy of the output data 514.

At optional step 410, process 400 may include updating the trained machine learning model 508 based on the feedback. For example, the feedback may be used as a label to create a new training dataset for use in retraining the machine learning model 508. Specifically, based on the analysis of the feedback performed during the monitoring process 520, a portion of the input data 512 and the corresponding monitoring data 518 may be provided as one or more new training datasets (e.g., the corresponding monitoring data 518 serving as the label) to retrain the trained machine learning model 508 using the machine learning model training process 506. Resultantly, one or more aspects of the trained machine learning model 508, such as the weights and bias, may be further modified or tuned for improved accuracy of the model. In some examples, the machine learning model 508 may be retrained after a predefined number of new training datasets have been received. The retrained machine learning model 508 be se stored for subsequent deployment. (e.g., the process 400 returns to step 406).

FIG. 6 depicts an exemplary shared link notification 604 provided to a receiving user, according to certain aspects. The shared link notification 604, hereinafter notification 604, may be received from the link sharing system 110 via the link sharing application and displayed via a user interface of a browser (e.g., browser user interface 600) executing on one of the receiving user computing devices 104. For example, the application may be a browser extension application that adds functionality, such as link sharing functionality, to the browser executing on the receiving user computing device 104.

The link sharing system 110 may monitor web browser activity of a receiving user. The notification 604 may be displayed in response to detecting navigation to any page of a site of a merchant associated with one or more links 606 shared with the receiving user, such as a home page 602 of the merchant site, via the web browser executing on the receiving user computing device 104. In this example, at least Sharing User 1 and Sharing User 2 respectively shared a first link 606A and a second link 606B (collectively links 606) with the receiving user. Display of the notification 604 while the receiving user is currently navigated to the merchant site (e.g., while the receiving user may already be in a mindset to interact with the merchant) may increase engagement with the notification 604, and thus increase a likelihood that the receiving user redeems the code associated with at least one of the links 606 that is included within the notification 604.

The notification 604 may include a first prompt 608 indicating that one or more users have shared links 606 (e.g., a referral link) and redemption of the referral (e.g., by redeeming a code associated with one of the links 606) may provide the receiving user with an offer, deal, discount, or other similar incentive. For each sharing user having shared one of links 606, the notification 604 may include a respective section 610A, 610B (collectively sections 610). The sections 610 may be positioned, ordered, or otherwise arranged based on a priority of the sharing users determined, for example, via the processes described above with reference to step 206 of FIG. 2 and step 350 of FIG. 3C. For example, a position of section 610A relative to (e.g., above) section 610B indicates Sharing User 1 has a higher priority than Sharing User 2.

The sections 610 may identify a corresponding sharing user and the link 606 shared by the sharing users. Additionally, the sections 610 may also include a copy control element 612A, 612B (collectively copy control elements 612) and a redeem control element 614A, 614B (collectively redeem control elements 614). Selection of the copy control element 612 from one of the sections 610 may automatically copy the respective link 606 included within the section 610. In some examples, once copied, the receiving user may manually navigate to a page of the merchant site that is associated with the respective link 606 to proceed with the redemption process by pasting the copied link 606 into the web browser in the same or a new browser tab. Alternatively, the receiving user may paste the copied link 606 into another source (e.g., an electronic communication and/or a document). Selection of the redeem control element 614 from one of the sections 610 may automatically navigate the web browser to the page of the merchant site that is associated with the respective link 606 included within the section 610 in the same or a new browser tab to enable the receiving user to proceed with the redemption process.

The notification 604 may further include a display control element 616 that allows the receiving user to select whether or not the link sharing system 110 displays notifications to the receiving user when navigating websites associated with shared links received by the user, such as the notification 604 on the home page 602 (e.g., allows the receiving user to opt in or out of receiving notifications of this type). A respective selection by the receiving user may be saved to the account preferences and/or settings of the receiving user's link sharing account in the account profile data store 118, for example,

The notification 604 described above is provided merely as an example, and may include additional, fewer, different, or differently arranged information and/or interactive control elements than depicted in FIG. 6.

FIG. 7 depicts another exemplary shared link notification 704 provided to a receiving user, according to certain aspects. The shared link notification 704, hereinafter notification 704, may be received from the link sharing system 110 via the link sharing application and displayed via a user interface of a browser (e.g., browser user interface 700) executing on one of the receiving user computing devices 104. For example, the application may be a browser extension application that adds functionality, such as link sharing functionality, to the browser executing on the receiving user computing device 104.

The link sharing system 110 may monitor web browser activity of the receiving users. While monitoring, the link sharing system 110 may detect that search results of a search engine executing on the receiving user computing device 104 include a site of a merchant associated with one or more links 606 shared with the receiving user. Using a similar example as FIG. 6, at least Sharing User 1 and Sharing User 2 respectively shared links 606 with the receiving user. In response to such detection, the notification 704 may be displayed as an embedded notification within a search results page 702 on the browser user interface 700. The notification 704 may be displayed in association with (e.g., adjacent to, underneath, etc.) the merchant's site within the search results provided on the search results page 702.

The notification 704 may include the same or similar features as the notification 604 described in detail with reference to FIG. 6. For example, the notification 704 may include the first prompt 608 and the sections 610 corresponding to the sharing users, where each of the sections 610 may include the link 606, the copy control element 612, and the redeem control element 614. Similar to FIG. 6, sections 610 may be positioned, ordered, or otherwise arranged based on a determined priority of the sharing users. Although not shown, the notification 704 may also include a display element similar to display control element 616 that allows the receiving user to select whether or not the link sharing system 110 displays notifications embedded within search results, such as the notification 704 on the search results page 702 (e.g., allows the receiving user to opt in or out of receiving notifications of this type).

The notification 704 described above is provided merely as an example, and may include additional, fewer, different, or differently arranged information and/or interactive control elements than depicted in FIG. 7.

FIG. 8 depicts an exemplary use notification 800 provided to a sharing user, according to certain aspects. As described in detail with reference to step 314 of the process 300 of FIG. 3A, the updating of the validity status of a shared link from valid to invalid may also cause the use notification 800 to be generated and provided to the respective sharing user computing device 102 for display. In some examples, the notification 800 may be displayed on a web browser of the sharing user computing device 102 (e.g., if and/or when the web browser is next launched) via a browser extension version of the application. In other examples, the notification 800 may be provided as an electronic communication to the sharing user (e.g., a push notification to a local version of the link sharing application executing on the sharing user computing device 102, an email, a text message, and instant message).

The notification 800 may include an indicator 802 that the code associated with the link has been redeemed by one of the receiving users (e.g., the first receiving user). Based on the code now being invalid due to the redemption by first receiving user, the notification 800 may include a first prompt 804 asking for the sharing user to reactively provide one or more new links with one or more associated new codes to enable each of the remaining receiving users, such as the second receiving user, and/or new receiving users to be able to use or redeem a similar offer or deal associated with the link. The notification 800 may include one or more text boxes 806 into which the sharing user may paste the new links into. For example, based on the sharing user's interactions with the merchant, the sharing user may have accrued multiple referral or other similar links associated with the merchant to share with other users. The new link may be one of those accrued links. In some examples, the link sharing system 110 may be configured to save the accrued links in association with the sharing user's link sharing account, and may automatically select the new link from the saved links upon a request from the sharing user to add the new link. In such examples, the link sharing system 110 may automatically populate one or more of the text boxes 806 with an accrued and saved link as previously discussed.

In some examples, the notification 800 may request a confirmation 808 from the sharing user as to which remaining one or more receiving users (e.g., which of the receiving users selected by the sharing user that were not the first to redeem the code) to share the new links with. Additionally, the notification 800 may provide a second prompt 810 that provides the sharing user an option to select one or more other users to share the link with (e.g., other users not initially selected to receive the link). The second prompt 810 may be accompanied by a text box enabling the sharing user to input contact information of the other user(s). In other examples, the second prompt 810 may be accompanied by a drop down menu for selecting among associated users and/or contact information for the associated users that are automatically displayed. For example, the information for the associated users may be retrieved from the account profile data store 118 and/or the optional social network graph data store 128, and automatically displayed within the drop down menu.

Once the sharing user has added one or more new links and has confirmed which remaining receiving users and/or selected other users to share the link with, the sharing user may select a share control element 812 of the notification 800 to cause distribution of the new links to respective receiving user computing devices 104 of the confirmed and/or selected users.

As described herein, the user notification 800 is a reactive notification. In other examples, a proactive notification may be generated and provided to the sharing user. For example, the proactive notification may be generated and provided in response to determining that a code of the link being shared by the user is a non-reusable code or a limited use code. The proactive notification may prompt provision of the new links prior to the initial distribution of the links to the receiving users such that one or more of the receiving users receive unique codes to prevent redemption by one receiving user preventing or blocking redemption by other receiving users.

The notification 800 described above is provided merely as examples, and may include additional, fewer, different, or differently arranged information and/or interactive control elements than depicted in FIG. 8.

FIG. 9 depicts an exemplary reward notification 900 provided to a sharing user, according to certain aspects. In some examples, the reward notification 900, hereinafter notification 900, may be generated and provided by a respective merchant system 140. The sharing user may receive a bonus, reward, or other similar incentive from the merchant when a predefined number of codes (e.g., one or more codes) of shared links associated with the merchant have been used or redeemed. To facilitate tracking, as a code of a link shared by the sharing user is used by a receiving user, the unique string of characters within the code that is assigned to the sharing user by the merchant may be used by the merchant to identify and credit the sharing user with one redeemed code (e.g., a redeemed referral). The notification 900 may be provided to the sharing user to indicate how close the sharing user is toward obtaining the bonus, reward, or other similar incentive.

In some examples, the notification 900 may be displayed on a web browser of the sharing user computing device 102 (e.g., if and/or when the web browser is next launched) via a browser extension version of the application. In other examples, the notification 900 may be provided as an electronic communication to the sharing user (e.g., a push notification to a local version of the link sharing application executing on the sharing user computing device 102, an email, a text message, and instant message).

To indicate how close the sharing user is toward obtaining the bonus, reward, or other similar incentive, the notification 900 may include a first number of codes 902 that have been used or redeemed and/or a second number of codes 904 that still need to be used or redeemed in order for the sharing user to obtain the bonus, reward, or other similar incentive. In some examples, additional information associated with the first number of codes 902 may be displayed, such as the receiving users who used the codes, dates when the codes were used, etc. In further examples, the notification 900 may also enable the sharing user to share the link with additional receiving users. For example, the notification 900 may include features similar to the second prompt 810 of notification 800 that may be accompanied by a text box enabling the sharing user to input contact information of the other user(s) and/or a drop down menu for selecting among associated users and/or contact information for the associated users that are automatically displayed.

As previously discussed above, the validity monitoring system 114 may track use of codes and reward status of the sharing user independently from the merchant system 140 providing the notification 900. For example, to facilitate tracking, as a code of a link shared by the sharing user is used by a receiving user and the validity status of the used code is updated, a number of used codes stored in association with the sharing user in the account information data store 120 (or optionally a separate reward status data store) may be incremented by one. In some examples, when the notification 900 is provided by the merchant system 140, the link sharing application executing on the sharing user computing device 102 may identify and extract the first number of codes 902 from the notification 900. The link sharing application may provide the first number of codes 902 to the validity monitoring system 114 to perform a comparison with the number of used codes stored in association with the sharing user in the account information data store 120. In some examples, if the first number of codes 902 does not match the number of used codes stored, the number of used codes stored may be updated to reflect the first number of codes 902.

In general, any process or operation discussed in this disclosure that is understood to be computer-implementable, such as the processes or operations depicted in FIGS. 2-9, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

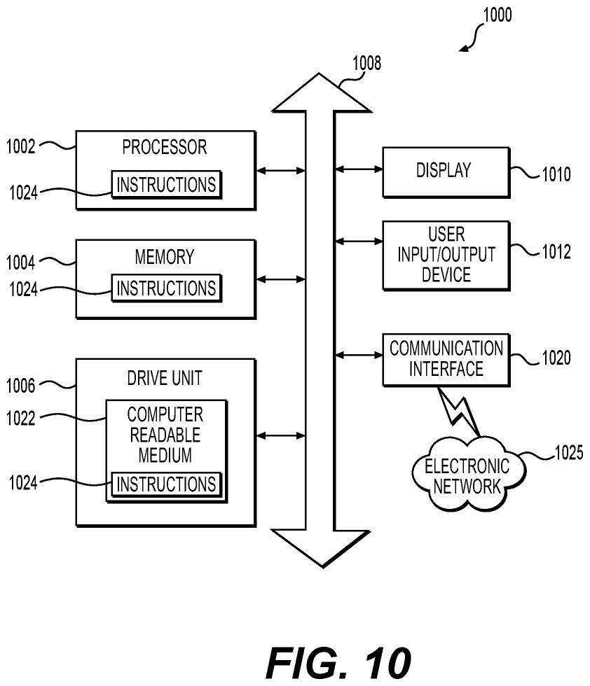

FIG. 10 depicts an example of a computer 1000, according to certain aspects. FIG. 10 is a simplified functional block diagram of a computer 1000 that may be configured as a device for executing processes or operations depicted in, or described with respect to, FIGS. 2-9, according to exemplary aspects of the present disclosure. For example, the computer 1000 may be configured as one of the sharing user computing devices 102, receiving user computing devices 104, one of the server-side systems 108, and/or another device according to exemplary aspects of this disclosure. In various aspects, any of the systems herein may be a computer 1000 including, e.g., a data communication interface 1020 for packet data communication. The computer 1000 may communicate with one or more other computers 1000 using the electronic network 1025. The electronic network 1025 may include a wired or wireless network similar to the network 106 depicted in FIG. 1.

The computer 1000 also may include a central processing unit (“CPU”), in the form of one or more processors 1002, for executing program instructions 1024. The program instructions 1024 may include instructions for running the link sharing application associated with the link sharing system 110 (e.g., if the computer 1000 is one of the sharing user computing devices 102 and/or one of the receiving user computing devices 104). The program instructions 1024 may include instructions for running one or more operations of the server-side systems 108 (e.g., if the computer 1000 is a server device or other similar computing device of one or more of the respective server-side systems 108). The computer 1000 may include an internal communication bus 1008, and a drive unit 1006 (such as read-only memory (ROM), hard disk drive (HDD), solid-state disk drive (SDD), etc.) that may store data on a computer readable medium 1022, although the computer 1000 may receive programming and data via network communications. The computer 1000 may also have a memory 1004 (such as random access memory (RAM)) storing instructions 1024 for executing techniques presented herein, although the instructions 1024 may be stored temporarily or permanently within other modules of computer 1000 (e.g., processor 1002 and/or computer readable medium 1022). The computer 1000 also may include user input and output ports 1012 and/or a display 1010 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be understood that aspects in this disclosure are exemplary only, and that other aspects may include various combinations of features from other aspects, as well as additional or fewer features. For example, while some of the aspects above pertain to training and/or using one or more trained machine learning models for targeted link sharing, any suitable activity may be used.

It should be appreciated that in the above description of exemplary aspects of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method comprising:
detecting an interaction with a site on a computing device associated with a receiving user;
determining the receiving user has received a plurality of shared links associated with the site from a plurality of sharing users, wherein each of the plurality of shared links and information associated with the plurality of shared links, including a validity status of the plurality of shared links, are stored in a data store;
determining a priority of the plurality of sharing users based on a prioritization mechanism associated with the receiving user;
based on the priority, generating and providing a notification for display on the computing device, the notification including at least one shared link from the plurality of shared links that is associated with a highest priority sharing user based on the determined priority;
detecting a use of a code associated with the at least one shared link; and
based on the use of the code, updating a validity status of the at least one shared link stored in the data store from valid to invalid.

2. The computer-implemented method of claim 1, further comprising:
receiving historical shared link engagement data associated with the receiving user, the historical shared link engagement data including, for each historical shared link displayed on the computing device or another computing device associated with the receiving user, information associated with the respective historical shared link and a level of engagement with the respective historical shared link;
providing the historical shared link engagement data and information associated with the at least one shared link as input to a machine learning system trained to predict a likelihood of engagement with the at least one shared link,
receiving a predicted likelihood of engagement with the at least one shared link; and
based on the predicted likelihood of engagement at least meeting a predefined threshold, generating and displaying the notification.

3. The computer-implemented method of claim 1, wherein the notification further includes at least two shared links, and the at least two shared links are positioned or ordered relative to one another in the notification to indicate a relative priority of corresponding sharing users from the plurality of sharing users.

4. The computer-implemented method of claim 1, wherein the prioritization mechanism associated with the receiving user includes alternating priority among sharing users or prioritizing at least one of:
sharing users assigned to a priority group by the receiving user,
sharing users having engaged with links shared by the receiving user,
sharing users having shared a threshold number of links with the receiving user,
sharing users most recently sharing links with the receiving user,
sharing users least recently sharing links with the receiving user, or
sharing users closest to obtaining a reward.

5. The computer-implemented method of claim 1, wherein the information stored in the data store further includes conditions for using a code associated with each of the plurality of shared links, and detecting the use of the code associated with the at least one shared link includes:
monitoring for interactions indicating the use of the code based on the conditions stored in the data store.

6. The computer-implemented method of claim 5, wherein monitoring for the interactions indicating the use of the code comprises:
detecting a selection of the at least one shared link;
detecting a loading of a first page of the site on the computing device responsive to the selection of the at least one shared link; and
detecting a loading of a second page of the site on the computing device, the second page associated with an interaction indicating the use of the code.

7. The computer-implemented method of claim 5, wherein monitoring for the interactions indicating the use of the code comprises:
accessing a plurality of communications received by a communication account associated with the receiving user; and
parsing the plurality of communications to identify at least one communication associated with the site that indicates the use of the code.

8. The computer-implemented method of claim 1, wherein a sharing user of the at least one shared link provided the at least one shared link to the receiving user and one or more other receiving users, and the updating of the validity status of the at least one shared link from valid to invalid prevents the at least one shared link from being displayed to the one or more other receiving users when an interaction with the site is detected on one or more computing devices associated with the one or more other receiving users.

9. The computer-implemented method of claim 8, further comprising:
generating and providing a use notification to a computing device associated with the sharing user of the at least one shared link to indicate the use and prompt provision of a new shared link associated with the site to share with the one or more other receiving users.

10. The computer-implemented method of claim 1, wherein detecting the interaction with the site on the computing device associated with the receiving user comprises one of:
detecting navigation to the site via a web browser executing on the computing device; or
detecting the site included in search results of a search engine executing on the computing device.

11. The computer-implemented method of claim 10, wherein generating and displaying the notification comprises:
generating and displaying the notification based on a type of the interaction detected with the site, wherein a browser notification is generated and displayed on the web browser when the type of the interaction detected is navigation to the site via the web browser, and an embedded notification is generated and displayed within the search results when the type of the interaction detected is the site included in the search results.

12. A computer-implemented method comprising:
receiving a request from a first computing device associated with a sharing user to share a link with a first receiving user and a second receiving user, wherein the link is associated with a site and includes a code that is non-reusable;
storing the link and information associated with the link, including a validity status of the link as valid and conditions for using the code, in a data store;
detecting an interaction with the site on a second computing device associated with the first receiving user;
generating and providing a first notification including the link for display on the second computing device;
monitoring for interactions indicating a use of the code based on the conditions stored in the data store;
detecting the use of the code based on the monitoring;
based on the use of the code, updating the validity status of the link from valid to invalid in the data store;
generating and providing a second notification to the first computing device to indicate the use and prompt provision of a new link associated with the site to share with the second receiving user; and
receiving the new link, wherein when an interaction with the site is detected on a third computing device associated with the second receiving user, the new link is included in a third notification generated and provided for display on the third computing device.

13. The computer-implemented method of claim 12, wherein monitoring for interactions indicating a use of the code comprises at least one of:
detecting a selection of the link;
detecting a loading of a first page of the site on the second computing device responsive to the selection of the link; or
detecting a loading of a second page of the site on the second computing device, the second page associated with an interaction indicating the use of the code.

14. The computer-implemented method of claim 12, wherein monitoring for interactions indicating a use of the code comprises:
accessing a plurality of communications received by a communication account associated with the first receiving user; and
parsing the plurality of communications to identify at least one communication associated with the site that indicates the use of the code.

15. The computer-implemented method of claim 12, wherein a reward is provided to the sharing user based on a predefined number of used codes of links associated with the site and shared by the sharing user, and the method further comprising:
storing a number of used codes of links associated with the site and shared by the sharing user in another data store; and
based on the use of the code, incrementing the number of used codes in the other data store.

16. The computer-implemented method of claim 15, further comprising:
detecting navigation to the site on the first computing device associated with the sharing user, the site including an indication of a number of used codes of links associated with the site and shared by the sharing user; and
comparing the number of used codes indicated by the site with the number of used codes stored in the other data store.

17. The computer-implemented method of claim 12, wherein detecting the interaction with the site on the second computing device associated with the first receiving user comprises one of:
detecting navigation to the site via a web browser executing on the second computing device; or
detecting the site included in search results of a search engine executing on the second computing device.

18. The computer-implemented method of claim 17, wherein generating and displaying the notification comprises:
generating and displaying the notification based on a type of the interaction detected with the site, wherein a browser notification is generated and displayed on the web browser when the type of the interaction detected is navigation to the site via the web browser, and an embedded notification is generated and displayed within the search results when the type of the interaction detected is the site included in the search results.

19. A computer-implemented method comprising:
receiving a request from a first computing device associated with a sharing user to share a link with a plurality of receiving users, wherein the link is associated with a site and includes a code that is non-reusable;
storing the link and information associated with the link, including a validity status of the link as valid and conditions for using the code, in a data store;
detecting an interaction with the site on a second computing device associated with a first receiving user of the plurality of receiving users;
generating and displaying a notification including the link on the second computing device;
monitoring for interactions indicating a use of the code based on the conditions stored in the data store;
detecting the use of the code based on the monitoring; and
updating the validity status of the link stored in the data store from valid to invalid such that the link is not displayed to a second receiving user of the plurality of receiving users when an interaction with the site is detected on a third computing device associated with the second receiving user.

20. The computer-implemented method of claim 19, further comprising:
generating and providing a use notification to the first computing device associated with the sharing user to indicate the use of the code and prompt provision of one or more new links associated with the site to share with one or more other receiving users of the plurality of receiving users; and
receiving the one or more new links, wherein when the interaction with the site is detected on the third computing device associated with the second receiving user, one of the one or more new links is included in place of the link in another notification generated and provided for display on the third computing device.
